(19) United States
(12) Patent Application Publication
(10) Pub. No.: US 2017/0181498 A1
(43) Pub. Date: Jun. 29, 2017

(54) Footwear Compositions Comprising Propylene-Based Elastomers

(71) Applicant: ExxonMobil Chemical Patents Inc., Baytown, TX (US)

(72) Inventors: Declan N. Whelan, Rugby, Warwickshire (GB); Leander M. Kenens, Vlaams Brabant (BE)

(21) Appl. No.: 15/309,518

(22) PCT Filed: Jul. 2, 2015
(86) PCT No.: PCT/US15/38980

§ 371 Date: Nov. 8, 2016

Related U.S. Application Data
(60) Provisional application No. 62/029,046, filed on Jul. 25, 2014.

(51) Int. Cl. A43B 13/18; C08J 9/228

(52) U.S. Cl. CPC A43B 13/187; C08J 9/228; C08J 2423/16; C08J 2423/14; C08J 2423/08; C08J 2323/16; C08J 2323/14; C08J 2323/08

(57) ABSTRACT

Disclosed are footwear compositions comprising a propylene-based elastomer. The presence of the propylene-based elastomer provides the footwear sole with a well-balanced combination of desired properties, including low density, low compression set, and weldability.

### CROSS-REFERENCE TO RELATED APPLICATIONS

This application claims priority to and the benefit of U.S. Provisional Application Ser. No. 62/029,046, filed Jul. 25, 2014, the entirety of which is incorporated herein by reference.

### FIELD OF THE INVENTION

Described herein are footwear compositions, including footwear soles, which comprise propylene-based elastomers, and methods for making the same.

### BACKGROUND OF THE INVENTION

Footwear, i.e., shoes, often must exhibit a combination of key performance variables by virtue of the stresses resulting from long-term shoe wear. These variables include strength characteristics such as impact strength and durability, as well as characteristics more closely associated with shoe comfort, such as softness, lightness and resilience. An additional consideration in selecting footwear components is the ability of the components to be joined together. Conventional articles of footwear include two primary elements—a laminated sole attached to a soft and pliable upper. The shoe soles are often formed from foam materials, such as polyurethane, ethylene vinyl acetate (EVA) copolymers, or natural rubber compounds. The uppers are often formed from leather, synthetic leather, rubber materials, synthetic textiles, or other polymer materials. Once separately finished, the upper and the sole are sewn together, glued together, and/or welded together.

Foamed compositions based on EVA copolymers or polyurethane have been used extensively in footwear manufacture. While, crosslinked foams of EVA copolymers have excellent characteristics such as strength and cushioning property under moderate conditions, i.e., temperatures of 20 to 30° C., they often deteriorate at extreme conditions. For example, such compositions tend to harden and, hence, have deteriorated cushioning property under severe cold temperatures, for example at −10° C. or lower. In addition, in high temperature environments of 30° C. or higher, the ground often becomes heated to a temperature above the air temperature and, hence, the crosslinked foam can become excessively softened and have deteriorated cushioning property.

U.S. Patent Application Publication No. 2009/0172970 describes crosslinked foams for use in footwear containing the reaction product of (A) a polyolefin having a crystallinity of 21% or less, an EVA copolymer having a vinyl acetate content of less than 15 mol %, or combinations thereof, (B) a polyolefin having a viscosity between 500 and 20,000 cP, and (C) 10 to 80 parts by weight of filler, per 100 parts by weight of components A and B.

Chinese Patent Application Publication No. 103254508 describes foaming materials made from 40-80 parts of a propylene-based elastomer, 10-30 parts of modified resin, 20-40 parts of a filler, 0.8-1.4 parts of a cross-linking agent, 0.5-1.5 parts of a cross-linking accessory ingredient, 6-10 parts of a foaming agent, 0-1.6 parts of a foaming accessory ingredient, and 0-1.6 parts of a lubricating agent.

U.S. Patent Application Publication No. 2014/0208619 describes footwear soles comprising a propylene-based elastomer and an ethylene copolymer. The ethylene copolymer contains ethylene and a comonomer such as butene, hexene, octene, or 10-20 wt % propylene.

U.S. Patent Application Publication No. 2014/0336290 describes foamed compositions containing an ethylene-propylene-diene terpolymer, a propylene-based elastomer, and a foaming agent.

Other background references include U.S. Patent Application Publication No. 2013/0324658; U.S. Pat. Nos. 7,015,284, 7,073,277, 7,485,682, 7,605,217, 8,240,067, 8,245,417, 8,296,974, 8,461,222, 8,492,447, and 8,826,569; EP Patent Application Publication No. 1 872 924 A1, and PCT Publication No. WO 2010/050628A2.

There remains a need for a composition for manufacturing footwear, particularly, shoe soles, which can provide a balance between a set of desired properties including density, compression set, slip resistance, and abrasion durability. In particular, there is a need for compositions that can be used for footwear soles that have an improved balance of properties over a wide range of temperature conditions. Furthermore, there is a need for shoe sole compositions that have improved weldability, while maintaining instead of compromising other properties at their desired levels, which can reduce or eliminate the use of an adhesives for the bonding process of the upper and the sole.

### SUMMARY OF THE INVENTION

Described herein are footwear compositions, and in particular shoe sole compositions, comprising foams that comprise propylene-based elastomers. The presence of the propylene-based elastomer provides the footwear composition with a well-balanced combination of desired properties, including low density and low compression set.

The footwear compositions described herein comprise a foam that comprises a propylene-based elastomer and an ethylene-based copolymer. The propylene-based elastomer comprises propylene-derived units and from about 5 to about 30 wt % of α-olefin-derived units, based on the weight of the propylene-based elastomer. The propylene-based elastomer has at least four of the following properties:
(i) a melting temperature (Tm) of less than 110° C.;
(ii) a heat of fusion (Hf) of less than about 50 J/g;
(iii) a melt index of (ASTM D-1238; 2.16 kg, 190° C.) of less than or equal to about 10 g/10 min;
(iv) a melt flow rate (ASTM D-1238; 2.16 kg, 230° C.) of less than about 15 g/10 min;
(v) a weight average molecular weight (Mw) of from about 100,000 to about 500,000 g/mol;
(vi) a number average molecular weight (Mn) of from about 50,000 to about 500,000 g/mol;
(vii) a molecular weight distribution (Mw/Mn) of less than about 5; and/or
(viii) a Shore D hardness of less than about less than about 50.

The ethylene-based copolymer comprises ethylene-derived units and at least 20 wt % α-olefin derived units.

### DETAILED DESCRIPTION OF THE PRESENT INVENTION

Various specific embodiments and versions of the present invention will now be described, including preferred embodiments and definitions that are adopted herein. While the following detailed description gives specific preferred embodiments, those skilled in the art will appreciate that these embodiments are exemplary only, and that the present invention can be practiced in other ways. Any reference to the “invention” may refer to one or more, but not necessarily all, of the present inventions defined by the claims. The use of headings is for purposes of convenience only and does not limit the scope of the present invention.

All numerical values within the detailed description and the claims herein are modified by “about” or “approximately” the indicated value, and take into account experimental error and variations that would be expected by a person having ordinary skill in the art.

The term “polymer” as used herein includes, but is not limited to, homopolymers, copolymers, terpolymers, etc., and alloys and blends thereof. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

As used herein, the term “copolymer” is meant to include polymers having two or more monomers, optionally, with other monomers, and may refer to interpolymers, terpolymers, etc.

The term “monomer” or “comonomer,” as used herein, can refer to the monomer used to form the polymer, i.e., the unreacted chemical compound in the form prior to polymerization, and can also refer to the monomer after it has been incorporated into the polymer, also referred to herein as a “[monomer]-derived unit”. Herein, when a polymer is said to comprise a certain percentage, wt %, of a monomer, that percentage of monomer is based on the total amount of monomer units in the polymer.

“Polypropylene,” as used herein, includes homopolymers and copolymers of propylene or mixtures thereof. Products that include one or more propylene monomers polymerized with one or more additional monomers may be more commonly known as random copolymers (RCP) or impact copolymers (ICP). Impact copolymers may also be known in the art as heterophasic copolymers.

“Propylene-based,” as used herein, is meant to include any polymer comprising propylene, either alone or in combination with one or more comonomers, in which propylene is the major component (i.e., the polymer contains greater than 50 wt % propylene-derived units).

“Reactor grade,” as used herein, means a polymer that has not been chemically or mechanically treated or blended after polymerization in an effort to alter the polymer's average molecular weight, molecular weight distribution, or viscosity. Particularly excluded from those polymers described as reactor grade are those that have been visbroken or otherwise treated or coated with peroxide or other prodegradants. For the purposes of this disclosure, however, reactor grade polymers include those polymers that are reactor blends.

“Reactor blend,” as used herein, means a highly dispersed and mechanically inseparable blend of two or more polymers produced in situ as the result of sequential or parallel polymerization of one or more monomers with the formation of one polymer in the presence of another in series reactors, or by solution blending polymers made separately in parallel reactors. Reactor blends may be produced in a single reactor, a series of reactors, or parallel reactors and are reactor grade blends. Reactor blends may be produced by any polymerization method, including batch, semi-continuous, or continuous systems. Particularly excluded from “reactor blend” polymers are blends of two or more polymers in which the polymers are blended ex situ, such as by physically or mechanically blending in a mixer, extruder, or other similar device.

“Visbreaking,” as used herein, is a process for reducing the molecular weight of a polymer by subjecting the polymer to chain scission. The visbreaking process also increases the MFR of a polymer and may narrow its molecular weight distribution. Visbreaking of a polymer can be performed by different types of chemical reactions, such as thermal pyrolysis, exposure to oxidizing agents, exposure to ionizing radiation, and addition of a prodegradant. A prodegradant is a substance that promotes chain scission when mixed with a polymer, which is then heated under extrusion conditions. Examples of prodegradants include peroxides, such as alkyl hydroperoxides and dialkyl peroxides. These materials, at elevated temperatures, initiate a free radical chain reaction resulting in scission of the polymer molecule. The terms “prodegradant” and “visbreaking agent” are used interchangeably herein. Polymers that have undergone chain scission via a visbreaking process are said herein to be “visbroken.” Such visbroken polymer grades, particularly polypropylene grades, are often referred to in the industry as “controlled rheology” or “CR” grades.

As used herein, a “plastomer” shall mean ethylene based copolymers, i.e., copolymers comprising greater than 50 wt % ethylene-derived units, having a density in the range of about 0.85 to 0.915 g/cm³. Plastomers include copolymers of ethylene and higher α-olefins such as 1-butene, 1-hexene, and 1-octene, and copolymers of ethylene and 1-20 wt % propylene-derived units.

As used herein, “phr” is parts per hundred rubber or “parts”, and is a measure common in the art wherein components of a composition are measured relative to a major elastomer component(s), based upon 100 parts by weight of the elastomer(s) or rubber(s).

As used herein, “room temperature” shall mean the temperature range of about 20° C. to about 23.5° C.

As used herein, the bonding process conducted “without” use of an adhesive refers to the bonding process substantially devoid of use of an adhesive, which means the adhesive is not added deliberately during the bonding process and, if present, is present in an amount of less than about 1 g per each upper and sole being bonded together.

Described herein are compositions comprising propylene-based elastomers that are suitable for footwear applications, particularly shoe sole compositions. In preferred embodiments, the compositions comprise a propylene-based elastomer and an ethylene-based copolymer and are used to form foams. The compositions provide a balance of density, compression set, slip resistance, and abrasion durability. In particular, the compositions have an improved balance of properties, such as compression set, over a wide range of temperature conditions.

### Propylene-Based Elastomer

The compositions described herein comprise one or more propylene-based polymers, such as propylene-based elastomers (“PBEs”). The PBE comprises propylene, from about 5 to about 30 wt % of one or more comonomers selected from ethylene and/or C₄-C₁₂ α-olefins, and, optionally, one or more dienes. For example, the comonomer units may be derived from ethylene, butene, pentene, hexene, 4-methyl-1-pentene, octene, or decene. In preferred embodiments, the comonomer is ethylene. In some embodiments, the PBE consists essentially of propylene and ethylene, or consists only of propylene and ethylene. In some embodiments, the PBE consists essentially of propylene, ethylene, and diene, or consists only of propylene, ethylene, and diene. Some of the embodiments described below are discussed with reference to ethylene as the comonomer, but the embodiments are equally applicable to PBEs with other α-olefin comonomers. In this regard, the copolymers may simply be referred to as PBEs with reference to ethylene as the α-olefin.

The PBE may include at least about 5 wt %, at least about 7 wt %, at least about 9 wt %, at least about 10 wt %, at least about 12 wt %, or at least about 15 wt %, α-olefin-derived units, based upon the total weight of the PBE. The PBE may include up to about 30 wt %, up to about 25 wt %, up to about 22 wt %, up to about 20 wt %, up to about 17 wt %, up to about 15 wt %, up to about 13 wt %, or up to about 12 wt %, α-olefin-derived units, based upon the total weight of the PBE. In some embodiments, the PBE may comprise from about 7 to about 25 wt %, from about 9 to about 22 wt %, or from about 10 wt % to about 20 wt %, α-olefin-derived units, based upon the total weight of the PBE. In some embodiments, the PBE may comprise from about 9 to about 17 wt %, from about 10 to about 15 wt %, or from about 10 wt % to about 12 wt %, α-olefin-derived units, based upon the total weight of the PBE. In some embodiments, the PBE may comprise from about 10 to about 25 wt %, from about 12 to about 20 wt %, or from about 15 wt % to about 17 wt %, α-olefin-derived units, based upon the total weight of the PBE.

The PBE may include at least about 70 wt %, at least about 75 wt %, at least about 78 wt %, at least about 80 wt %, at least about 83 wt %, at least 85 wt %, at least 87 wt %, or at least 88 wt %, propylene-derived units, based upon the total weight of the PBE. The PBE may include up to about 95 wt %, up to about 93 wt %, up to about 91 wt %, up to about 90 wt %, up to about 88 wt %, or up to about 85 wt %, propylene-derived units, based upon the total weight of the PBE.

The PBE can be characterized by a melting point (Tm), which can be determined by differential scanning calorimetry (DSC). Using the DSC test method described herein, the melting point is the temperature recorded corresponding to the greatest heat absorption within the range of melting temperature of the sample. When a single melting peak is observed, that peak is deemed to be the “melting point.” When multiple peaks are observed (e.g., principal and secondary peaks), then the melting point is deemed to be the highest of those peaks. It is noted that at the low-crystallinity end at which elastomers are commonly found, the melting point peak may be at a low temperature and be relatively flat, making it difficult to determine the precise peak location. A “peak” in this context is thus defined as a change in the general slope of the DSC curve (heat flow versus temperature) from positive to negative, forming a maximum without a shift in the baseline where the DSC curve is plotted so that an endothermic reaction would be shown with a positive peak.

The Tm of the PBE (as determined by DSC) may be less than about 110° C., less than about 105° C., less than about 100° C., less than about 90° C., less than about 80° C., less than about 70° C., less than about 65° C., or less than about 60° C. In some embodiments, the PBE may have a Tm of from about 20 to about 110° C., from about 30 to about 110° C., from about 40 to about 110° C., or from about 50 to about 105° C., where desirable ranges may include ranges from any lower limit to any upper limit. In some embodiments, the PBE may have a Tm of from about 40 to about 70° C., or from about 45 to about 65° C., or from about 50 to about 60° C., where desirable ranges may include ranges from any lower limit to any upper limit. In some embodiments, the PBE may have a Tm of from about 80 to about 110° C., or from about 85 to about 110° C., or from about 90 to about 105° C., where desirable ranges may include ranges from any lower limit to any upper limit.

The PBE can be characterized by its heat of fusion (Hf), as determined by DSC. The PBE may have an Hf that is at least about 1.0 J/g, at least about 3.0 J/g, at least about 5.0 J/g, at least about 7.0 J/g, at least about 10.0 J/g, or at least about 12 J/g. The PBE may be characterized by an Hf of less than about 50 J/g, less than about 40 J/g, less than about 35 J/g, less than about 30 J/g, less than about 25 J/g, less than about 20 J/g, less than about 17 J/g, or less than 15 J/g. The PBE may have a Hf of from about 1.0 to about 40 J/g, from about 3.0 to about 30 J/g, or from about 5.0 to about 20 J/g, where desirable ranges may include ranges from any lower limit to any upper limit. In some embodiments, the PBE may have a Hf of from about 1.0 to about 15 J/g or from about 3.0 to about 10 J/g, where desirable ranges may include ranges from any lower limit to any upper limit. In some embodiments, the PBE may have a Hf of from 5.0 to about 30 J/g, from about 7.0 to about 25 J/g, or from about 12 to about 20 J/g, where desirable ranges may include ranges from any lower limit to any upper limit.

As used herein, DSC procedures for determining Tm and Hf are as follows. The polymer is pressed at a temperature of from about 200° C. to about 230° C. in a heated press, and the resulting polymer sheet is hung, under ambient conditions, in the air to cool. About 6 to 10 mg of the polymer sheet is removed with a punch die. This 6 to 10 mg sample is annealed at room temperature for about 80 to 100 hours. At the end of this period, the sample is placed in a DSC (Perkin Elmer Pyris One Thermal Analysis System) and cooled to about −30° C. to about −50° C. and held for 10 minutes at that temperature. The sample is then heated at 10° C./min to attain a final temperature of about 200° C. The sample is kept at 200° C. for 5 minutes. Then a second cool-heat cycle is performed, where the sample is again cooled to about −30° C. to about −50° C. and held for 10 minutes at that temperature, and then re-heated at 10° C./min to a final temperature of about 200° C. Events from both cycles are recorded. The thermal output is recorded as the area under the melting peak of the sample, which typically occurs between about 0° C. and about 200° C., is measured in Joules and is a measure of the Hf of the polymer.

Preferably, the PBE has crystalline regions interrupted by non-crystalline regions. The non-crystalline regions can result from regions of non-crystallizable propylene segments, the inclusion of comonomer units, or both. In one or more embodiments, the PBE has a propylene-derived crystallinity that is isotactic, syndiotactic, or a combination thereof. In a preferred embodiment, the PBE has isotactic sequences. The presence of isotactic sequences can be determined by NMR measurements showing two or more propylene derived units arranged isotactically. Such isotactic sequences can, in some cases be interrupted by propylene units that are not isotactically arranged or by other monomers that otherwise disturb the crystallinity derived from the isotactic sequences.

The PBE can have a triad tacticity of three propylene units (mmm tacticity), as measured by 13C NMR, of 75% or greater, 80% or greater, 85% or greater, 90% or greater, 92% or greater, 95% or greater, or 97% or greater. In one or more embodiments, the triad tacticity may range from about 75 to about 99%, from about 80 to about 99%, from about 85 to about 99%, from about 90 to about 99%, from about 90 to about 97%, or from about 80 to about 97%, where desirable ranges may include ranges from any lower limit to any upper limit. Triad tacticity may be determined by the methods described in U.S. Pat. No. 7,232,871.

The PBE may have a tacticity index m/r ranging from a lower limit of 4 or 6 to an upper limit of 8 or 10 or 12, where desirable ranges may include ranges from any lower limit to any upper limit. The tacticity index, expressed herein as “m/r”, is determined by ¹³C nuclear magnetic resonance (“NMR”). The tacticity index, m/r, may be calculated as defined by H. N. Cheng in Vol. 17, MACROMOLECULES, pp. 1950-1955 (1984), incorporated herein by reference. The designation “m” or “r” describes the stereochemistry of pairs of contiguous propylene groups, “m” referring to meso and “r” to racemic. An m/r ratio of 1.0 generally describes a syndiotactic polymer, and an m/r ratio of 2.0 describes an atactic material. An isotactic material theoretically may have a ratio approaching infinity, and many by-product atactic polymers have sufficient isotactic content to result in ratios of greater than 50.

The PBE may have a percent crystallinity determined according to DSC procedures of from about 0.5% to about 40%, from about 1% to about 30%, or from about 5% to about 25%, where desirable ranges may include ranges from any lower limit to any upper limit. Crystallinity may be determined by dividing the Hf of a sample by the Hf of a 100% crystalline polymer, which is assumed to be 189 J/g for isotactic polypropylene.

The comonomer content and sequence distribution of the polymers can be measured using ¹³C nuclear magnetic resonance (NMR) by methods well known to those skilled in the art. Comonomer content of discrete molecular weight ranges can be measured using methods well known to those skilled in the art, including Fourier Transform Infrared Spectroscopy (FTIR) in conjunction with samples by GPC, as described in Wheeler and Willis, Applied Spectroscopy, 1993, Vol. 47, pp. 1128-1130. For a propylene ethylene copolymer containing greater than 75 wt % propylene, the comonomer content (ethylene content) of such a polymer can be measured as follows: A thin homogeneous film is pressed at a temperature of about 150° C. or greater, and mounted on a Perkin Elmer PE 1760 infrared spectrophotometer. A full spectrum of the sample from 600 cm-1 to 4000 cm-1 is recorded and the monomer weight percent of ethylene can be calculated according to the following equation: Ethylene wt %=82.585−111.987X+30.045X2, where X is the ratio of the peak height at 1155 cm-1 and peak height at either 722 cm-1 or 732 cm-1, whichever is higher. For propylene ethylene copolymers having 75 wt % or less propylene content, the comonomer (ethylene) content can be measured using the procedure described in Wheeler and Willis. Reference is made to U.S. Pat. No. 6,525,157 which contains more details on GPC measurements, the determination of ethylene content by NMR and the DSC measurements.

The PBE has a density of from about 0.84 g/cm³ to about 0.92 g/cm³, from about 0.85 g/cm³ to about 0.90 g/cm³, or from about 0.86 g/cm³ to about 0.88 g/cm³ at room temperature, as measured per the ASTM D-1505 test method, where desirable ranges may include ranges from any lower limit to any upper limit.

The PBE can have a melt index (MI) (ASTM D-1238, 2.16 kg @ 190° C.), of less than or equal to about 10 g/10 min, less than or equal to about 8.0 g/10 min, less than or equal to about 5.0 g/10 min, less than or equal to about 3 g/10 min, or less than or equal to about 2.0 g/10 min. In some embodiments, the PBE has a MI of from about 0.5 to about 3.0 g/10 min or form about 0.75 to about 2.0 g/10 min, where desirable ranges may include ranges from any lower limit to any upper limit.

The PBE may have a melt flow rate (MFR), as measured according to ASTM D-1238 (2.16 kg weight @ 230° C.), greater than about 0.5 g/10 min, greater than about 1.0 g/10 min, greater than about 1.5 g/10 min, greater than about 2.0 g/10 min, or greater than about 2.5 g/10 min. The PBE may have an MFR less than about 15 g/10 min, less than about 10 g/10 min, less than about 7 g/10 min, or less than about 5 g/10 min. The PBE may have an MFR from about 0.5 to about 10 g/10 min, from 0.75 to about 8 g/10 min, from about 0.75 to about 7 g/10 min, or from about 0.75 to about 5 g/10 min, where desirable ranges may include ranges from any lower limit to any upper limit.

The PBE may have a g′ index value of 0.95 or greater, or at least 0.97, or at least 0.99, wherein g′ is measured at the Mw of the polymer using the intrinsic viscosity of isotactic polypropylene as the baseline. For use herein, the g′ index is defined as:

$${g}^{′} = \frac{{η}_{b}}{{η}_{l}}$$

where ηb is the intrinsic viscosity of the polymer and ηl is the intrinsic viscosity of a linear polymer of the same viscosity-averaged molecular weight (Mv) as the polymer. ηl=KMvα, K and α are measured values for linear polymers and should be obtained on the same instrument as the one used for the g′ index measurement.

The PBE may have a weight average molecular weight (Mw), as measured by MALLS, of from about 100,000 to about 500,000 g/mol, from about 125,000 to about 400,000 g/mol, from about 150,000 to about 350,000 g/mol, from about 200,000 to about 300,000 g/mol, or from about 225,000 to about 290,000 g/mol, where desirable ranges may include ranges from any lower limit to any upper limit. In some embodiments, the PBE may have a Mw of from about 175,000 to about 260,000 g/mol, from about 190,000 to about 250,000 g/mol, from about 200,000 to about 250,000 g/mol, or from about 210,000 to about 240,000 g/mol where desirable ranges may include ranges from any lower limit to any upper limit. In some embodiments, the PBE may have a Mw of from about 240,000 to about 300,000 g/mol, from about 250,000 to about 290,000 g/mol, or from about 260,000 to about 285,000 g/mol, where desirable ranges may include ranges from any lower limit to any upper limit.

The PBE may have a number average molecular weight (Mn), as measured by DRI, of from about 50,000 to about 500,000 g/mol, from about 60,000 to about 300,000 g/mol, from about 80,000 to about 250,000 g/mol, from about 90,000 to about 200,000 g/mol, or from about 100,000 to about 150,000 g/mol, where desirable ranges may include ranges from any lower limit to any upper limit. In some embodiments, the PBE may have a Mn of from about 90,000 to about 130,000 g/mol, from about 95,000 to about 125,000 g/mol, or from about 100,000 to about 120,000 g/mol, where desirable ranges may include ranges from any lower limit to any upper limit. In some embodiments, the PBE may have a Mn of from about 110,000 to about 140,000 g/mol, from about 115,000 to about 135,000 g/mol, or from about 120,000 to about 130,000 g/mol, where desirable ranges may include ranges from any lower limit to any upper limit.

The molecular weight distribution (MWD, equal to Mw/Mn) of the PBE may be from about 0.5 to about 10, from about 0.75 to about 5, from about 1.0 to about 5, from about 1.5 to about 4, or from about 1.8 to about 3, where desirable ranges may include ranges from any lower limit to any upper limit.

The PBE may have a Shore D hardness of less than about less than about 50, less than about 45, less than about 40, less than about 35, or less than about 20. In some embodiments, the PBE may have a Shore D hardness of from about 10 to about 50, from about 15 to about 45, or from about 20 to about 40, where desirable ranges may include ranges from any lower limit to any upper limit.

In some embodiments, the PBE is a propylene-ethylene copolymer that has at least four, or at least five, or at least six, or at least seven, or at least eight, or all nine of the following properties: (i) from about 9 to about 17 wt %, or from about 10 to about 15 wt %, or from about 10 wt % to about 12 wt %, ethylene-derived units based on the weight of the PBE; (ii) a Tm of from about 40 to about 70° C., or from about 45 to about 65° C., or from about 50 to about 60° C.; (iii) a Hf of from about 5.0 to about 30 J/g, or from about 7.0 to about 25 J/g, or from about 12 to about 20 J/g; (iv) a MI of from about 0.5 to about 3.0 g/10 min or from about 0.75 to about 2.0 g/10 min; (v) a MFR of from about 0.5 to about 10 g/10 min, or from 0.75 to about 8 g/10 min, or from about 0.75 to about 7 g/10 min, or from about 0.75 to about 5 g/10 min; (vi) a Mw of from about 240,000 to about 300,000 g/mol, or from about 250,000 to about 290,000 g/mol, or from about 260,000 to about 285,000 g/mol; (vii) a Mn of from about 110,000 to about 140,000 g/mol, or from about 115,000 to about 135,000 g/mol, or from about 120,000 to about 130,000 g/mol; (viii) a MWD of from about 0.5 to about 10, or from about 0.75 to about 5, or from about 1.0 to about 5, from about 1.5 to about 4, or from about 1.8 to about 3; and/or (ix) a Shore D hardness of from about 10 to about 50, or from about 15 to about 45, or from about 20 to about 40.

In some embodiments, the PBE is a propylene-ethylene copolymer that has at least four, or at least five, or at least six, or at least seven, or at least eight, or all nine of the following properties (i) from about 10 to about 25 wt %, or from about 12 to about 20 wt %, or from about 15 wt % to about 17 wt % ethylene-derived units, based on the weight of the PBE; (ii) a Tm of from 80 to about 110° C., or from about 85 to about 110° C., or from about 90 to about 105° C.; (iii) a Hf of from about 1.0 to about 15 J/g or from about 3.0 to about 10 J/g; (iv) a MI of from about 0.5 to about 3.0 g/10 min or from about 0.75 to about 2.0 g/10 min; (v) a MFR of from about 0.5 to about 10 g/10 min, or from 0.75 to about 8 g/10 min, or from about 0.75 to about 7 g/10 min, or from about 0.75 to about 5 g/10 min; (vi) a Mw of from about 175,000 to about 260,000 g/mol, or from about 190,000 to about 250,000 g/mol, or from about 200,000 to about 250,000 g/mol, or from about 210,000 to about 240,000 g/mol; (vii) a Mn of from about 90,000 to about 130,000 g/mol, or from about 95,000 to about 125,000 g/mol, or from about 100,000 to about 120,000 g/mol; (viii) a MWD of from about 0.5 to about 10, or from about 0.75 to about 5, or from about 1.0 to about 5, or from about 1.5 to about 4, or from about 1.8 to about 3; and/or (ix) a Shore D hardness of less than 30, or less than 25, or less than 20. In some embodiments, such a PBE is a reactor-blended PBE as described herein.

Optionally, the PBE may also include one or more dienes. The term “diene” is defined as a hydrocarbon compound that has two unsaturation sites, i.e., a compound having two double bonds connecting carbon atoms. Depending on the context, the term “diene” as used herein refers broadly to either a diene monomer prior to polymerization, e.g., forming part of the polymerization medium, or a diene monomer after polymerization has begun (also referred to as a diene monomer unit or a diene-derived unit). In some embodiments, the diene may be selected from 5-ethylidene-2-norbornene (ENB); 1,4-hexadiene; 5-methylene-2-norbornene (MNB); 1,6-octadiene; 5-methyl-1,4-hexadiene; 3,7-dimethyl-1,6-octadiene; 1,3-cyclopentadiene; 1,4-cyclohexadiene; vinyl norbornene (VNB); dicyclopentadiene (DCPD), and combinations thereof. In embodiments where the propylene-based polymer comprises a diene, the diene may be present at from 0.05 wt % to about 6 wt %, from about 0.1 wt % to about 5.0 wt %, from about 0.25 wt % to about 3.0 wt %, or from about 0.5 wt % to about 1.5 wt %, diene-derived units, based upon the total weight of the PBE.

Optionally, the PBE may be grafted (i.e., “functionalized”) using one or more grafting monomers. As used herein, the term “grafting” denotes covalent bonding of the grafting monomer to a polymer chain of the propylene-based polymer. The grafting monomer can be or include at least one ethylenically unsaturated carboxylic acid or acid derivative, such as an acid anhydride, ester, salt, amide, imide, acrylates or the like. Illustrative grafting monomers include, but are not limited to, acrylic acid, methacrylic acid, maleic acid, fumaric acid, itaconic acid, citraconic acid, mesaconic acid, maleic anhydride, 4-methyl cyclohexene-1,2-dicarboxylic acid anhydride, bicyclo(2.2.2)octene-2,3-dicarboxylic acid anhydride, 1,2,3,4,5,8,9,10-octahydronaphthalene-2,3-dicarboxylic acid anhydride, 2-oxa-1,3-diketospiro(4.4)nonene, bicyclo(2.2.1)heptene-2,3-dicarboxylic acid anhydride, maleopimaric acid, tetrahydrophthalic anhydride, norbornene-2,3-dicarboxylic acid anhydride, nadic anhydride, methyl nadic anhydride, himic anhydride, methyl himic anhydride, and 5-methylbicyclo(2.2.1)heptene-2,3-dicarboxylic acid anhydride. Other suitable grafting monomers include methyl acrylate and higher alkyl acrylates, methyl methacrylate and higher alkyl methacrylates, acrylic acid, methacrylic acid, hydroxy-methyl methacrylate, hydroxyl-ethyl methacrylate and higher hydroxy-alkyl methacrylates and glycidyl methacrylate. Maleic anhydride is a preferred grafting monomer. In embodiments wherein the graft monomer is maleic anhydride, the maleic anhydride concentration in the grafted polymer is preferably in the range of about 1 wt % to about 6 wt %, at least about 0.5 wt %, or at least about 1.5 wt %.

In some embodiments, the PBE is a reactor blended polymer as defined herein. That is, the PBE is a reactor blend of a first polymer component and a second polymer component. Thus, the comonomer content of the propylene-based polymer can be adjusted by adjusting the comonomer content of the first polymer component, adjusting the comonomer content of second polymer component, and/or adjusting the ratio of the first polymer component to the second polymer component present in the propylene-based polymer.

In embodiments where the PBE is a reactor blended polymer, the α-olefin content of the first polymer component (“R₁”) may be greater than 5 wt %, greater than 7 wt %, greater than 10 wt %, greater than 12 wt %, greater than 15 wt %, based upon the total weight of the first polymer component. The α-olefin content of the first polymer component may be less than 30 wt %, less than 27 wt %, less than 25 wt %, less than 22 wt %, less than 20 wt %, or less than 19 wt %, based upon the total weight of the first polymer component. In some embodiments, the α-olefin content of the first polymer component may range from 5 wt % to 30 wt %, from 7 wt % to 27 wt %, from 10 wt % to 25 wt %, from 12 wt % to 22 wt %, from 15 wt % to 20 wt %, or from 16 wt % to 19 wt %, based upon the total weight of the first polymer component. Preferably, the first polymer component comprises propylene and ethylene, and in some embodiments the first polymer component consists only of propylene and ethylene derived units. However, in some embodiments, the first polymer component may further comprise diene, such that the first polymer component consists essentially of propylene, ethylene, and diene, or consists only of propylene, ethylene, and diene-derived units.

In embodiments where the propylene-based polymer is a reactor blended polymer, the α-olefin content of the second polymer component (“R₂”) may be greater than 1.0 wt %, greater than 1.5 wt %, greater than 2.0 wt %, greater than 2.5 wt %, greater than 2.75 wt %, or greater than 3.0 wt %, based upon the total weight of the second polymer component. The α-olefin content of the second polymer component may be less than 10 wt %, less than 9 wt %, less than 8 wt %, less than 7 wt %, less than 6 wt %, or less than 5 wt %, based upon the total weight of the second polymer component. In some embodiments, the α-olefin content of the second polymer component may range from 1.0 wt % to 10 wt %, or from 1.5 wt % to 9 wt %, or from 2.0 wt % to 8 wt %, or from 2.5 wt % to 7 wt %, or from 2.75 wt % to 6 wt %, or from 3 wt % to 5 wt %, based upon the weight of the second polymer component. Preferably, the second polymer component comprises propylene and ethylene, and in some embodiments the first polymer component consists only of propylene and ethylene derived units. However, in some embodiments, the first polymer component may further comprise diene, such that the first polymer component consists essentially of propylene, ethylene, and diene, or consists only of propylene, ethylene, and diene-derived units.

In embodiments where the PBE is a reactor blended polymer, the PBE may comprise from 1 to 25 wt %, from 3 to 20 wt %, from 5 to 18 wt %, from 7 to 15 wt %, or from 8 to 12 wt % of the second polymer component, based on the weight of the PBE. The propylene-based polymer may comprise from 75 to 99 wt %, from 80 to 97 wt %, from 85 to 93 wt %, or from 82 to 92 wt % of the first polymer component, based on the weight of the PBE.

The PBE are preferably prepared using homogeneous conditions, such as a continuous solution polymerization process. In some embodiments, the PBE are prepared in parallel solution polymerization reactors. Exemplary methods for the preparation of PBEs may be found in U.S. Pat. Nos. 6,881,800; 7,803,876; 8,013,069; and 8,026,323 and PCT Publications WO 2011/087729; WO 2011/087730; and WO 2011/087731.

### Ethylene-Based Copolymer

In addition to the propylene-based elastomers described above, the compositions described herein may further include one or more ethylene-based copolymers. In preferred embodiments, the ethylene-based copolymer is an ethylene-α-olefin copolymer or an ethylene-α-olefin-diene copolymer.

The ethylene-α-olefin copolymer contains ethylene-derived units and units derived from an α-olefin having 3 to 8 carbon atoms, and in preferred embodiments the α-olefin is propylene. The ethylene-α-olefin copolymer may contain at least 50 wt %, at least 55 wt %, at least 60 wt %, at least 65 wt %, or at least 70 wt % of ethylene-derived units, based on the weight of the ethylene-α-olefin copolymer, with the balance of the units being α-olefin derived. The ethylene-α-olefin copolymer may contain at least 20 wt %, or at least 21 wt %, or at least 22 wt %, or at least 23 wt % α-olefin derived units, such as propylene-derived units. Ethylene-α-olefin copolymers, such as ethylene-propylene rubbers, that can be vulcanized using free radical generators, such as organic peroxides, are further described in U.S. Pat. No. 5,177,147.

The ethylene-α-olefin-diene copolymer contains ethylene-derived units, α-olefin-derived units, and diene-derived units. The α-olefin may have 3 to 8 carbon atoms. In preferred embodiments the α-olefin is propylene, and the copolymer is an ethylene-propylene-diene copolymer. Preferably the diene in is a nonconjugated diene, such as 5-ethylidene-2-norbomene (“ENB”); 1,4-hexadiene; 5-methylene-2-norbomene; 1,6-octadiene; 5-methyl-1,4-hexadiene; 3,7-dimethyl-1,6-octadiene; 1,3-cyclopentadiene; 1,4-cyclohexadiene; dicyclopentadiene (“DCPD”); 5-vinyl-2-norbornene (“VNB”); divinyl benzene, or combinations thereof. In some embodiments, the ethylene-α-olefin-diene copolymer comprises diene-derived units derived from ENB, VNB, or combinations thereof. In preferred embodiments, the ethylene-α-olefin diene copolymers consists essentially of, or consists only of, units derived from ethylene, propylene, and ENB. The ethylene-α-olefin-diene copolymer may contain at least 50 wt %, at least 55 wt %, at least 60 wt %, at least 65 wt %, or at least 70 wt % of ethylene-derived units, based on the weight of the ethylene-α-olefin-diene copolymer. The ethylene-α-olefin-diene copolymer may contain at least 20 wt %, or at least 21 wt %, or at least 22 wt %, or at least 23 wt % α-olefin derived units, such as propylene-derived units. The ethylene-α-olefin-diene copolymer may contain less than 5 wt %, or less than 4 wt %, or less than 3 wt %, or less than 2 wt %, or less than 1 wt % of diene-derived units, based on the weight of the ethylene-α-olefin-diene copolymer.

The ethylene content of the ethylene-α-olefin copolymer may be determined by ASTM D3900, and is not corrected for diene content. The diene content of an ethylene-α-olefin-diene copolymer containing ENB may be determined by FTIR, ASTM D6047. The diene content of an ethylene-α-olefin-diene copolymer containing VNB may be measured via ¹H NMR. These methods measure available unsaturation. Thus, the measured incorporation may be lower than the actual incorporation because dienes having pendant unsaturated moieties have been converted, e.g., by hydrogen, and are not detected in the measurement. If the EPDM contains both ENB and VNB, ¹³C NMR is preferably used to determine the diene content.

The ethylene-based copolymer may have a Mooney viscosity (ML [1+4] 125° C.; ASTM D1646) of less than 50, or less than 45, or less than 40, or less than 35, or less than 30, or less than 25.

In one or more embodiments, the ethylene-based copolymer has a high molecular weight, such that the weight average molecular weight (Mw) of the copolymer is greater than 100,000 g/mole, greater than 200,000 g/mole, greater than 400,000 g/mole, or greater than 600,000 g/mole. The Mw of the ethylene-based copolymer may be less than 1,200,000 g/mole, less than 1,000,000 g/mole, less than 900,000 g/mole, or less than 800,000 g/mole. Useful ethylene-based copolymers may have a number average molecular weight (Mn) that is greater than 20,000 g/mole, greater than 60,000 g/mole, greater than 100,000 g/mole, or greater than 150,000 g/mole. The Mn of the ethylene-based copolymer may be less than 500,000 g/mole, less than 400,000 g/mole, less than 300,000 g/mole, or less than 250,000 g/mole. Techniques for determining the molecular weight (Mₙ, M_{w}, and M_{z}) and molecular weight distribution (MWD) may be found in U.S. Pat. No. 4,540,753, which is incorporated by reference herein, and references cited therein and in Macromolecules, 1988, volume 21, p. 3360 by VerStrate et al., which is also herein incorporated by reference, and references cited therein.

The ethylene-based copolymer may have a broad molecular weight distribution. In some embodiments, the ethylene-based copolymer has a bimodal composition, such that it comprises a high molecular weight first polymer fraction, and a low molecular weight second polymer fraction. The multimodal ethylene-based copolymer preferably comprises between about 45 wt % and about 75 wt % of the first polymer fraction, based on the total weight of the first polymer fraction and the second polymer fraction (or fractions) present in the composition. Within this range, the multimodal ethylene-based copolymer preferably comprises about 45-55 wt % of the first polymer fraction, with the remainder of the polymer in the composition comprising the second polymer fraction. In a preferred embodiment, the weight percent (based on the total polymer weight) of ethylene in the first polymer fraction and the weight percent of ethylene in the second polymer fraction differ by no more than about 20 wt %, preferably by no more than about 10 wt %. Also, in a preferred embodiment, the weight percent diene in each fraction differs by no more than about 8 wt %, preferably by no more than about 3 wt %, more preferably by no more than about 2 wt %, and most preferably by no more than about 1 wt % diene.

In some embodiments, the ethylene-based copolymer is chosen such that it has an improved speed and level of crosslinking in a foamed composition.

The ethylene-based copolymers described herein may be manufactured or synthesized by using a variety of techniques. For example, these copolymers can be synthesized by employing solution, slurry, or gas phase polymerization techniques that employ various catalyst systems. Exemplary catalysts include Ziegler-Natta systems such as those including vanadium catalysts, and single-site catalysts including constrained geometry catalysts, or metallocene catalysts. Useful ethylene-based copolymers include some grades of rubbers commercially available under the trade names Vistalon™ (ExxonMobil Chemical Co.; Houston, Tex.), Keltan™ (DSM Copolymers), Nordel™ IP (Dow), Nordel™ MG (Dow), Royalene™ (Lion Copolymer), and Buna™ (Lanxess).

### Foaming Agent

The compositions used for the footwear soles described herein may be foamed by the addition of at least one physical or chemical foaming agent. The use of a foamed polymer allows the footwear designer to adjust the density or mass distribution of the footwear sole to control foot motion and provide cushioning. Foamed materials can also offer a potential cost savings due to the reduced use of polymeric material.

The foam cell structure may also play a role in terms of the foam's resistance to penetration. For instance, foams with a large population of voids near the surface may have less resistance to penetration than one with less surface voids. Foams may have primarily open or closed cell structures and a distribution of cell sizes. Foams with closed cell structure can exhibit reduced compression set, so that the shoe part, such as shoe sole, will not flatten with prolonged compressive loading. Closed cell foams can also impart good resilience and elasticity, and thus endurance and durability while under continuous load. Conversely, foams with an open cell structure may lead to greater cushioning properties of the sole. The use of structural foams as described herein can allow for a balancing of cushioning, compression set, flexibility, and wear.

Useful physical foaming agents include any naturally occurring atmospheric material which is a vapor at the temperature and pressure at which the foam generates on exposure to decompression. The physical blowing agent may be introduced, i.e., injected into the polymeric material as a gas, a supercritical fluid, or liquid, preferably as a supercritical fluid or liquid, most preferably as a liquid. The physical foaming agents used will depend on the properties sought in the resulting foam articles. Other factors considered in choosing a foaming agent are its toxicity, vapor pressure profile, ease of handling, and solubility with regard to the polymeric materials used. Non-flammable, non-toxic, non-ozone depleting foaming agents are preferred because they are easier to use and are generally less soluble in thermoplastic polymers. Suitable physical foaming agents include, e.g., carbon dioxide, nitrogen, nitrous oxide, perfluorinated fluids, such as argon, helium, noble gases, such as xenon, air (nitrogen and oxygen blend), hydrocarbons (e.g., C4, C5) and blends of these materials.

Chemical foaming agents that may be used include, e.g., azodicarbonamide; azobisformamide; azobisisobutyronitrile; diazoaminobenzene; N,N-dimethyl-N,N-dinitroso terephthalamide; N,N-dinitrosopentamethylene-tetramine; benzenesulfonyl-hydrazide; benzene-1,3-disulfonyl hydrazide; diphenylsulfon-3-3, disulfonyl hydrazide; 4,4′-oxybis benzene sulfonyl hydrazide; p-toluene sulfonyl semicarbizide; barium azodicarboxylate; butylamine nitrile; nitroureas; trihydrazino triazine; phenyl-methyl-uranthan; p-sulfonhydrazide; peroxides; and inorganic foaming agents such as ammonium bicarbonate and sodium bicarbonate. In some preferred embodiments, the foaming agent comprises azodicarbonamide (ADC), which is chemically designated as H₂NC(═O)N═NC(═O)NH₂.

In some embodiments, the foaming agent may comprise microspheres that encapsulate a liquid blowing agent. The term “microspheres” or “polymeric microspheres” as used herein means a thermally expandable spherical and hollow polymer product with an outer shell. Useful microspheres include those described in U.S. Pat. Nos. 3,615,972 and 4,075,138; and Japanese Patent Publication No. 59-98564 [Japanese Patent Publication (KOKAI) 60-244511]. A heat expandable microcapsule can be activated during the curing stage of a reaction injection molding process. Useful microspheres can include those available from Akzo Nobel Inc., under the trade name EXPANCEL™ which are spherically formed particles with a shell consisting of a thermoplastic resin that encapsulates the blowing agent, liquid isobutene.

As discussed above, the microspheres can include either a shell and encapsulated gas, or a shell and hydrocarbon or other chemical agent, which can result a volumetric expansion after exposure to thermal energy. The shell can be made from any polymeric materials. Examples of encapsulated gasses include CO2 or N2. The hydrocarbon includes a chemical blowing agent, for example, isobutane, isopentane, azo compounds, or any chemical blowing agent which releases CO2 or N2 upon exposure to thermal or radiation energy.

Useful foaming agents can include those commercially available under the trade names GENITRON™, POROFOR™, FICEL™ (Lanxess AG, Germany), SUVA™ DYMEL™, FORMACEL™, ZYRON™ (DuPont Chemical Company, Wilmington, Del., USA), PLANAGEN™ (INBRA S.A., Brazil), Fascom (West & Senior Ltd, Manchester, United Kingdom) and EXXSOL™ (ExxonMobil Chemical Company, Houston, Tex., USA).

The final foam may have an average cell size of from about 5 to about 2,000, preferably from about 20 to about 1,000, and more preferably about 50 to about 500 microns according to ASTM D3576-77. In preferred embodiments, the foams produced herein have numerous small cells of consistent size.

The total amount of the foaming agent used depends on conditions such as extrusion-process conditions at mixing, the foaming agent being used, the composition of the extrudate, and the desired density of the foamed article. The foaming agent can be employed in an amount of about 1 phr to about 10 phr, or about 2 phr to about 8 phr, or about 3 phr to about 6 phr, relative to the total of the polymer to be foamed, i.e., the propylene-based elastomer and the ethylene-based copolymer (if present).

In some embodiments, a nucleating agent may also be used to aid in regulating cell formation and morphology. A nucleating agent, or cell size control agent, may be any conventional or useful nucleating agent(s). The amount of nucleating agent used depends upon the desired cell size, the selected foaming agent blend, and the desired foam density. The nucleating agent is generally added in amounts from about 0.02 to about 20 wt % of the composition. Some contemplated nucleating agents include inorganic materials (in small particulate form), such as clay, talc, silica, and diatomaceous earth. Other contemplated nucleating agents include organic nucleating agents that decompose or react at the heating temperature within an extruder to evolve gases, such as carbon dioxide, water, and/or nitrogen. One example of an organic nucleating agent is a combination of an alkali metal salt of a polycarboxylic acid with a carbonate or bicarbonate. Some examples of alkali metal salts of a polycarboxylic acid include, but are not limited to, the monosodium salt of 2,3-dihydroxy-butanedioic acid (commonly referred to as sodium hydrogen tartrate), the monopotassium salt of butanedioic acid (commonly referred to as potassium hydrogen succinate), the trisodium and tripotassium salts of 2-hydroxy-1,2,3-propanetricarboxylic acid (commonly referred to as sodium and potassium citrate, respectively), and the disodium salt of ethanedioic acid (commonly referred to as sodium oxalate), or polycarboxylic acid such as 2-hydroxy-1,2,3-propanetricarboxylic acid. Some examples of a carbonate or a bicarbonate include, but are not limited to, sodium carbonate, sodium bicarbonate, potassium carbonate, potassium bicarbonate, and calcium carbonate.

In some embodiments, gas permeation agents or stability control agents may also be employed to assist in preventing or inhibiting collapsing of the foam. Useful stability control agents may include partial esters of long-chain fatty acids with polyols, saturated higher alkyl amines, saturated higher fatty acid amides, complete esters of higher fatty acids, and combinations thereof.

### Curing Agents and Coagents

In some embodiments, the foam, and in particular the ethylene-based copolymer, is cured using a curing agent and/or coagent. In some embodiments, the propylene-based elastomer contains an unsaturation structure, such as diene-containing propylene-based elastomers, and may also be cured.

Cross-linking and curing agents include sulfur, zinc oxide, and fatty acids. Peroxide cure systems can also be used. Generally, polymer compositions can be crosslinked by adding curative molecules, for example sulfur, metal oxides (i.e., zinc oxide), organometallic compounds, radical initiators, etc., followed by heating. In particular, the following are common curatives that may be useful in the present invention: ZnO, CaO, MgO, Al₂O₃, CrO₃, FeO, Fe₂O₃, and NiO. These metal oxides can be used in conjunction with the corresponding metal stearate complex (e.g., Zn(Stearate)₂, Ca(Stearate)₂, Mg(Stearate)₂, and Al(Stearate)₃), or with stearic acid, and either a sulfur compound or an alkylperoxide compound. Crosslinked polymers that are suitable for use in this invention are preferably cured by an organic peroxide and a coagent.

Organic peroxides suitable for use in the compositions described herein include, but are not limited to 1,1-bis(t-butylperoxy)-3,5,5-trimethylcyclohexane; 1,1-bis(t-butylperoxy)cyclohexane; 2,2-bis(t-butylperoxy)octane; n-butyl-4,4-bis(t-butylperoxy)valerate; 2,2-bis(t-butylperoxy)butane; 2,5-dimethylhexane-2,5-dihydroxyperoxide; di-t-butyl peroxide; t-butylcumyl peroxide; dicumyl peroxide; alpha,alpha′-bis(t-butylperoxy-m-isopropyl)benzene; 2,5-dimethyl-2,5-di(t-butylperoxy)hexane; 2,5-dimethyl-2,5-di(t-butylperoxy)hexene-3; benzoyl peroxide, t-butylperoxybenzene; 2,5-dimethyl-2,5-di(benzoylperoxy)-hexane; t-butylperoxymaleic acid; and t-butylperoxyisopropylcarbonate. Preferred examples of organic peroxides include 2,5-dimethyl-2,5-di(t-butylperoxy)hexane, dicumyl peroxide, and alpha,alpha′-bis(t-butylperoxy-m-isopropyl)benzene.

The amount of peroxide compounded is generally in the range of from about 0.05 to about 5 phr, preferably in the range of about 0.1 to about 3 phr, relative to the weight of the polymer to be cured. This range is selected because if the peroxide is present in an amount too low, e.g., of less than 0.05 phr, the vulcanization rate may be insufficient which can lead to poor mold release. On the other hand, if the peroxide is present in an amount too high, e.g., of greater than 5 phr, the compression set of the cured polymer can become unacceptably high. The organic peroxides may be used singly or in combinations of two or more types.

When the polymer composition is at least partially crosslinked, the degree of crosslinking may be measured by dissolving the composition in a solvent for specified duration, and calculating the percent gel or unextractable component. The percent gel normally increases with increasing crosslinking levels. In some embodiments, the cured foam may have a degree of crosslinking such that the percent gel content is desirably in the crosslinkable component of the formulation is in the range from 5 to 100 wt %, as measured using xylene extractables.

In some embodiments, the foams may be at least partially crosslinked by exposing the blend to energetic photons, such as exposing the blend to electromagnetic radiation having a frequency greater than that of visible light, such as for example near ultraviolet radiation, extreme ultraviolet radiation, soft x-rays, hard x-rays, gamma rays, high-energy gamma rays, or electron beam “e-beam” radiation.

E-beam radiation is a form of ionizing energy that is generally characterized by its low penetration and high dose rates. The electrons are generated by equipment referred to as accelerators which are capable of producing beams that are either pulsed or continuous. The term “beam” is meant to include any area exposed to electrons, which may range from a focused point to a broader area, such as a line or field. The electrons are produced by a series of cathodes (electrically heated tungsten filaments) that generate a high concentration of electrons. These electrons are then accelerated across a potential. The accelerating potential is typically in the keV to MeV range (where eV denotes electron volts), depending on the depth of penetration required. The irradiation dose is usually measured in Gray (unit) but also in rads, where 1 Gy is equivalent to 100 rad, or, more typically, 10 kGy equals 1 Mrad. Commercial e-beam units generally range in energies from 50 keV to greater than 10 MeV (million electron volts).

Suitable e-beam equipment is available from E-BEAM Services, Inc., or from PCT Engineered Systems, LLC. In a particular embodiment, electrons are employed at a dose of about 100 kGy or less in multiple exposures. The source can be any electron beam unit operating in a range of about 50 KeV to greater than 10 MeV with a power output capable of supplying the desired dosage. The electron voltage can be adjusted to appropriate levels, which may be, for example, 100,000 eV; 300,000 eV; 1,000,000 eV; 2,000,000 eV; 3,000,000 eV; or 6,000,000 eV. A wide range of apparatuses for irradiating polymers and polymeric articles is available.

Effective e-beam irradiation is generally carried out at a dosage from about 10 kGy to about 100 kGy, or from about 20 to about 90 kGy, or from about 30 to about 80 kGy, or from about 50 to about 60 kGy. In a particular aspect of this embodiment, the irradiation is carried out at room temperature.

Without wishing to be bound by theory, it is believed that two competing processes occur upon irradiation of polymers comprising propylene and ethylene, such as the propylene-based elastomers described herein. In portions of the polymer chains containing pendant methyl groups (such as those polymer units derived from propylene), the carbon atoms in the polymer backbone are susceptible to chain scission upon irradiation, which results in lowered molecular weight. The irradiation process also breaks the bonds between carbon and hydrogen atoms comprising the backbones of the polymer chains, creating free radicals that are available to cross-link with free radicals on adjacent polymer chains. Thus, irradiation leads to cross-linking, which builds a polymer network, as well as scission, which disrupts formation of a broad polymer network. To provide polymers with good tensile and elastic properties, it is desired to reduce chain scission while encouraging crosslinking of adjacent polymer chains. In polymers containing predominantly propylene, the dominant mechanism which takes place upon irradiation is scissioning. In polyethylene polymers, on the other hand, the dominant mechanism is crosslinking. The inclusion of ethylene-derived units in the propylene-based elastomers described herein therefore enhances crosslinking and reduces chain scission, leading to improved crosslinking. In addition, the inclusion of a non-conjugated diene in the propylene-based elastomer, such as ENB, also creates a greater preference for crosslinking in the overall polymer blend.

To further optimize the polymer blends herein and enhance cross-linking, both a coagent and an antioxidant may be added to the composition in a compounding step prior to irradiation. Again without wishing to be bound by theory, it is believed that coagents enhance crosslinking behavior, while antioxidants suppress chain scission. The sum total, therefore, is improved crosslinking when compared to polymers lacking a coagent, an antioxidant, or both. In other words, the polymer chains of the compositions described herein stay longer in length due to reduced scissioning, thus forming a crosslinked network that extends over a greater distance within the polymer blend. This enhanced crosslinking in turn leads to improved tension set, elongation, stress, and other mechanical properties of the polymers.

Coagents employed in the curable part of the composition used for the footwear sole can include multifunctional unsaturated compounds such as trimethylolpropane trimethacrylate (TMPTMA), triallyl cyanurate, trimethacryl isocyanurate, triallyl isocyanurate, trimethallyl isocyanurate, triacryl formal, triallyl trimellitate, N,N′-m-phenylene bismaleimide, diallyl phthalate, tetraallylterephthalamide, tri(diallylamine)-s-triazine, triallyl phosphite, bis-olefins and N,N-diallylacrylamide.

The amount of coagent compounded is generally in the range of about 0.1 to about 10 phr relative to the weight of the polymer to be cured. This concentration range is selected because if the coagent is present in amounts too low, e.g., less than 0.1 phr, the crosslink density of the cured polymer may be unacceptable. On the other hand, if the coagent is present in amounts too high, e.g., above 10 phr, it can bloom to the surface during molding, resulting in poor mold release characteristics. The preferable range of coagent is about 0.2 to about 6 phr relative to the polymer to be cured. The coagent may be used singly or as a combination of two or more types.

In some embodiments, the crosslinking is carried out by UV exposure and the composition may further comprise one or more UV stabilizers. Suitable UV sensitizers may be selected from those organic chemical compounds conventionally employed to promote UV-initiated formation of radicals either by intramolecular homolytic bond cleavage or by intermolecular hydrogen abstraction. Such agents include organic compounds having aryl carbonyl or tertiary amino groups. Among the compounds suitable for use are benzophenone; acetophenone; benzil; benzaldehyde; o-chlorobenzaldehyde; xanthone; thioxanthone; 9,10-anthraquinone; 1-hydroxycyclohexyl phenyl ketone; 2,2-diethoxy acetophenone; dimethoxyphenylacetophenone; methyl diethanolamine; dimethylaminobenzoate; 2-hydroxy-2-methyl-1-phenylpropane-1-one; 2,2-di-sec-butoxy acetophenone; 2,2-dimethoxy-1,2-diphenylethan-1-one; benzil dimethoxyketal; benzoin methyl ether; and phenyl glyoxal. Upon exposure to UV radiation, a variety of photochemical transformations may occur, for example, the UV initiator may form free radical reactive fragments that react with the acrylate end groups of the multifunctional acrylic or methacrylic crosslinking agent. This initiates crosslinking of the polymer as well as homopolymerization of the acrylic or methacrylic crosslinking agent.

In some embodiments, the composition contains at least 0.1 wt % of a UV sensitizer, based on the total weight of the composition. For example, the amount of UV sensitizers(s) can range from a low of about 0.1 wt %, 0.2 wt %, 0.3 wt %, 0.5 wt %, or 1 wt %, to a high of about 2.5 wt %, 3 wt %, 5 wt %, 8 wt %, or 10 wt %, based on the total weight of the composition.

The wavelength spectrum of UV radiation used to effect the curing reaction typically corresponds to the absorption maximum of the UV initiator. The wavelength can be from about 10 nm to about 400 nm. Preferably, the wavelength is from about 100 to about 400 nm, preferably about 200 to about 350 nm. Suitable UV radiation sources include medium pressure mercury vapor lamps, electrodeless lamps, pulsed xenon lamps, and hybrid xenon/mercury vapor lamps. An exemplary arrangement comprises one or more lamps together with a reflector, which diffuses the radiation evenly over the surface to be irradiated. Suitable UV radiation equipment includes those available from Fusion UV System Inc., such as the F300-6 curing chamber.

### Polymer Additives

In some embodiments, the composition may further a polymer additive in addition to the propylene-based polymer and/or ethylene-based copolymers described above. In some embodiments, the polymer additive may be an ethylene-based plastomer.

Ethylene-based plastomers that may be useful include those comprising ethylene-derived units and one or more olefins selected from propylene and C₄-C₂₀ olefins (preferably 1-butene, 1-hexene, and/or 1-octene. The ethylene-based plastomer may have an ethylene content of from about 50 to about 90 wt %, from about 60 to about 85 wt %, from about 65 to about 80 wt %, or from about 65 to about 75 wt %, based on the weight of the ethylene-based plastomer, where desirable ranges may include ranges from any lower limit to any upper limit. The ethylene-based plastomer may further comprise, (i) propylene-derived units in an amount of less than 20 wt %, such as from about 10 to 20 wt %; (ii) butene-derived units in an amount of from greater than 15 wt %, or greater than 20 wt %, or greater than 25 wt %; (iii) hexene-derived units in an amount of from greater than 20 wt %, or greater than 25 wt %, or greater than 30 wt %; or (iv) octene-derived units in an amount of greater than 25 wt %, or greater than 30 wt %, or greater than 35 wt %, based on the weight of the ethylene-based plastomer.

Useful ethylene-based plastomers may have one or more of the following properties:

1) a density from a low of 0.85 g/cm³, 0.86 g/cm³, 0.87 g/cm³, 0.88 g/cm³, or 0.885 g/cm³ to a high of 0.91 g/cm³, 0.905 g/cm³, or 0.902 g/cm³. In some embodiments, the ethylene-based plastomer may have a density in the range of from 0.85 to 0.91 g/cm³, or 0.86 to 0.91 g/cm³, or 0.87 to 0.91 g/cm³, or 0.88 to 0.905 g/cm³, or 0.88 to 0.902 g/cm³, or 0.885 to 0.902 g/cm³, where desirable ranges may include ranges from any lower limit to any upper limit;

2) a heat of fusion (H_{f}) of 90 J/g or less, 70 J/g or less, 50 J/g or less, or 30 J/g or less. In some embodiments, the ethylene-based plastomer may have a Hf of from 10 to 70 J/g, or 10 to 50 J/g, or 10 to 30 J/g, where desirable ranges may include ranges from any lower limit to any upper limit;

3) a crystallinity from a low of 5 wt % to a high of 40%, 30%, or 20%, where desirable ranges may include ranges from any lower limit to any upper limit;

4) a melting point (Tₘ, peak first melt) of 100° C. or less, 95° C. or less, 90° C. or less, 80° C. or less, 70° C. or less, 60° C. or less, or 50° C. or less;

5) a crystallization temperature (Tₐ, peak) of 90° C. or less, 80° C. or less, 70° C. or less, 60° C. or less, 50° C. or less, or 40° C. or less;

6) a glass transition temperature (T_{g}) of −20° C. or less, −30° C. or less, or −40° C. or less;

7) a M_{w} of 30 to 2,000 kg/mol, 50 to 1,000 kg/mol, or 90 to 500 kg/mol, where desirable ranges may include ranges from any lower limit to any upper limit;

8) a M_{w}/Mₙ of 1 to 5, 1.4 to 4.5, 1.6 to 4, 1.8 to 3.5, or 1.8 to 2.5, where desirable ranges may include ranges from any lower limit to any upper limit; and/or

9) a melt index (MI, 2.16 kg at 190° C.) of 0.1 to 100 g/10 min, 0.3 to 60 g/10 min, 0.5 to 40 g/10 min, or 0.7 to 20 g/10 min, where desirable ranges may include ranges from any lower limit to any upper limit.

Useful ethylene-based plastomers include certain grades of those commercially available under the trade names EXACT™ (ExxonMobil Chemical Company, Houston, Tex., USA), AFFINITY™, ENGAGE™, FLEXOMER™ (The Dow Chemical Company, Midland, Mich., USA), and TAFMER™ (Mitsui Company, Japan).

### Additives

If desired the compositions described herein may further comprise one or more additives, such as fillers, colorants, light and heat stabilizers, anti-oxidants, acid scavengers, flame retardants, algae inhibitors, anti-microbiological and anti-fungus agents, processing aids, extrusion aids, etc., and combinations thereof.

Desirable fillers can be organic fillers and/or inorganic fillers. Organic fillers include such materials as carbon black, fly ash, graphite, cellulose, starch, flour, wood flour, and polymeric fibers like polyester-based, and polyamide-based materials. Preferred examples of inorganic fillers are calcium carbonate, talc, glass fibers, marble dust, cement dust, clay, feldspar, silica or glass, fumed silica, alumina, magnesium oxide, antimony oxide, zinc oxide, barium sulfate, calcium sulfate, aluminum silicate, calcium silicate, titanium dioxide, titanates, clay, nanoclay, organo-modified clay or nanoclay, glass microspheres, and chalk. Of these fillers, calcium carbonate, barium sulfate, antimony oxide, talc, silica/glass, glass fibers, alumina, aluminum trihydroxide, magnesium hydroxide, and titanium dioxide, and mixtures thereof are preferred.

The composition can optionally include one or more processing oils or aids. Suitable processing aids can include, but are not limited to, plasticizers, tackifiers, extenders, chemical conditioners, homogenizing agents and peptizers such as mercaptans, petroleum and vulcanized vegetable oils, mineral oils, paraffin oils, polybutene oils, naphthenic oils, aromatic oils, waxes, resins, rosins, or other synthetic fluids having a lower pour point, lower emission, etc., compared to paraffin or mineral oil and the like. Generally from 0 to 150 parts, 0 to 100 parts, or from 0 to 50 parts of processing oils, plasticizers, and/or processing aids per 100 parts of total polymer are employed.

Compositions, including thermoplastic blends according to embodiments disclosed herein may also contain anti-ozonants or anti-oxidants that are known to a rubber chemist of ordinary skill. The anti-ozonants may be physical protectants such as waxy materials that come to the surface and protect the part from oxygen or ozone or they may be chemical protectors that react with oxygen or ozone. Suitable chemical protectors include styrenated phenols, butylated octylated phenol, butylated di(dimethylbenzyl)phenol, p-phenylenediamines, butylated reaction products of p-cresol and dicyclopentadiene (DCPD), polyphenolic antioxidants, hydroquinone derivatives, quinoline, diphenylene antioxidants, thioester antioxidants, and blends thereof.

For providing additional stability against UV radiation, hindered amine light stabilizers (HALS) and UV absorbers may be also used. Suitable examples include TINUVIN™ 123, TINUVIN™ 144, TINUVIN™ 622, TINUVIN™ 765, TINUVIN™ 770, and TINUVIN™ 780, available from Ciba Specialty Chemicals, and CHEMISORB™ T944, available from Cytex Plastics, Houston Tex., USA. A Lewis acid may be additionally included with a HALS compound in order to achieve superior surface quality, as disclosed in U.S. Pat. No. 6,051,681. Other embodiments may include a heat stabilizer, such as IRGANOX™ PS 802 FL, for example. For some compositions, additional mixing processes may be employed to pre-disperse the heat stabilizers, anti-oxidants, anti-ozonants, carbon black, UV absorbers, and/or light stabilizers to form a masterbatch, and subsequently to form polymer blends therefrom.

### Methods for Manufacturing a Footwear Sole and Footwear

One method of producing the foams described herein is by using an extruder or other mixing device. In such embodiments, the foamable mixture (polymer, filler, foaming agent, etc., as desired) is extruded. As the mixture exits an extruder die and upon exposure to reduced pressure, the fugitive gas nucleates and forms cells within the polymer to create a foam article.

A second method of producing foams described herein may include compounding or melt kneading of the components (polymers, fillers, blowing agent, etc., as desired), such as in an extruder or melt kneader, to form an expandable composition. The expandable composition may then be injection molded into a hot mold, such as by using a MAIN Group S.P.A. injection molding machine for crosslinked foams, model E166S. Following injection of the mixture into the mold, the mold temperature may be raised to and/or maintained at a temperature sufficient to decompose the foaming agent. The mold may then be opened to allow for sudden bubble nucleation and foam expansion.

Other methods of producing the foams described herein include classical injection molding of an expandable composition into a cold mold. The cell formation initiates in the mold runner, with full decompression occurring on entry into the mold cavity giving rise to the final foam structure.

In some embodiments, the sole composition comprises two or more different compound formulations. For example, two or more different compound formulations may be used to form the final foam composition. This enables a final shoe sole composition that has differing final properties in different portions of the shoe sole enabling further engineering of the sole performance.

The foams may be crosslinked, as described above, using a peroxide curing agent in some embodiments. In other embodiments, the foams may be crosslinked using a radiation induced curing system, such as e-beam, gamma, or UV radiation. The radiation activated curing may be performed, in some embodiments, after the formation of a foam by the above described methods.

The mixing of the composition components may be carried out using any suitable mixing device, e.g., known as single, twin screw, Buss co-kneader, and BANBURY™ mixer. Mixing of the unsaturation-containing composition with the curing agent is typically carried out by methods such as absorption or solids blending followed by a temperature controlled thermoplastic process capable to control temperature and shear viscosity to prevent premature activation of the foaming agent and curing agent. In general, the temperature is kept below the activation temperature for foaming and crosslinking.

The composition used for manufacturing the footwear soles described herein can be processed via a variety of molding techniques, such as injection molding, compression molding, casting, etc. Preferably, footwear soles are produced via injection molding. Non-limiting exemplary injection molding conditions may include temperatures, pressures, and cycle times as indicated in Table 1.

TABLE 1
Injection Molding Conditions for Footwear Soles

| | Temperature | Injection | Cycle Times |
|---|---|---|---|
| | (° C.) | Pressure (mPa) | (sec) |
| Melt | 160-260 | Packing 25-180 | Filling and Packing 40-90 |
| Mold | 10-30 | Hold 5-25 | Hold 15-30 |
| Front/Back | | | Cooling Time 50-100 |
| | | | Screw Retraction 5-50 |

A method for manufacturing footwear may comprise the steps of: (a) preparing a composition comprising a propylene-based elastomer as described herein; and (b) forming a footwear sole comprising the composition in step (a). Preferably, the method further comprises the steps of: preparing a footwear upper; and attaching the footwear upper to the footwear sole. The footwear upper may be manufactured from leather, textile, canvas, rubber, or polymeric materials such as polyurerthanes, PVC, EVA, or propylene-based elastomers.

In at least one embodiment, the footwear upper is prepared by using a composition comprising a propylene-based elastomer. The composition used for the footwear upper may be the same or different than the composition used for the footwear sole. When the compositions are different, this means that at least one property of the polymer being used is different or that a different polymer is used. Preferably, the propylene-based elastomer used for the footwear upper is the same or similar one as used in the footwear sole. More preferably, the corresponding compositions based on the propylene-based elastomer in both the footwear upper and the footwear sole are identical.

The footwear sole may be attached to the footwear upper by any of various methods, such as, adhesive, heat bonding, welding or mechanical connection to form a complete article of footwear. Preferably, the footwear sole and the footwear upper are attached by welding. More preferably, the footwear sole and the footwear upper are attached without use of an adhesive, such as by welding by direct injection molding. Addition of the propylene-based elastomer described herein, especially when used with specific amounts of, e.g., about 50 phr to about 100 phr relative to the total of the propylene-based elastomer and the ethylene copolymer (if present), into the composition for manufacturing footwear soles can maintain post-crosslinking weld-ability at a level sufficient to achieve the possibility of eliminating use of an adhesive when bonding the footwear sole and the footwear upper by using the welding method only, which renders the footwear manufacturing process more efficient and more environmentally friendly.

Rather than obtaining one targeted property at the expense of another as in the manufacturing process using traditional materials for footwear, the footwear manufacturing method of the present invention can be conducted by the welding method during the bonding process of the upper and the sole while ensuring footwear soles maintain other targeted properties at desired levels.

The foam compositions comprising the propylene-based elastomers described herein can have one or more of the following properties:
(i) A density ranging from an upper limit of about 0.70 g/cm³, about 0.65 g/cm³, about 0.60 g/cm³, about 0.55 g/cm³, about 0.50 g/cm³, about 0.45 g/cm³, about 0.40 g/cm³, about 0.35 g/cm³, or about 0.30 g/cm³, to a lower limit of about 0.25 g/cm³, about 0.20 g/cm³, or about 0.15 g/cm³. The density may be measured by SATRA test method TM 134;
(ii) A wear resistance as measured by SATRA test method TM175 of less than 1000 mm³, or less than 900 mm³, or less than 800 mm³, or less than 700 mm³, or less than 600 mm³, or less than 500 mm³, or less than 400 mm³, or less than 300 mm³, or less than 200 mm³, or less than 100 mm³;
(iii) A Shore A hardness of less than 95;
(iv) A slip resistance as indicated by the coefficient of friction at dry conditions of at least about 0.30, or at least about 0.40 or at least about 0.50, or at least about 0.60, or at least about 0.70, or at least about 0.80, or at least about 0.90, or at least about 1.00. The slip resistance may be measured by SATRA test method TM 144 (dry);
(v) A slip resistance as indicated by the coefficient of friction at wet conditions of at least about 0.30, or at least about 0.40 or at least about 0.50, or at least about 0.60, or at least about 0.70, or at least about 0.80, or at least about 0.90, or at least about 1.00. The slip resistance may be measured by SATRA test method TM 144 (wet);
(vi) A colorfastness to light of at least about 4 as measured by SATRA test method TM 160;
(vii) A DIN abrasion resistance as measured by SATRA test method TM 170 of less than or equal to about 250 mm³, or less than or equal to about 225 mm³, or less than or equal to about 200 mm³, or less than or equal to about 175 mm³, or less than or equal to about 170 mm³, or less than or equal to about 160 mm³, or less than or equal to about 150 mm³;
(viii) A compression set at room temperature as measured by SATRA test method TM 65 of less than about 30%, or less than about 25%, or less than about 20%, or less than about 15%, or less than about 12%, or less than about 10%;
(ix) A compression set at 50° C. as measured by SATRA test method TM 65 of less than about 75%;
(x) A lengthwise heat shrinkage as measured by SATRA test method TM 70 of less than about 2%, or less than about 1.5%, or less than about 1.0%, or less than about 0.75%, or less than about 0.6%;
(xi) A crosswise heat shrinkage as measured by SATRA test method TM 70 of less than about 2%, or less than about 1.5%, or less than about 1.0%, or less than about 0.75%, or less than about 0.6%, or less than about 0.5%, or less than about 0.4%, or less than about 0.3%;
(xii) An along split tear strength as measured by SATRA test method TM 65 of at least 2.0 N/mm, or at least 2.2 N/mm, or at least 2.4 N/mm, or at least 2.6 N/mm, or at least 3 N/mm;
(xiii) An across split tear strength as measured by SATRA test method TM 65 of at least 2.0 N/mm, or at least 2.2 N/mm, or at least 2.4 N/mm, or at least 2.6 N/mm, or at least 3 N/mm, or at least 3.2 N/mm, or at least 3.4 N/mm, or at least 3.6 N/g, or at least 3.8 N/m, or at least 4.0 N/mm;
(xiv) An along stitch tear strength as measured by SATRA test method TM 5 of at least 25 N/mm, or at least 26 N/mm, or at least 27 N/mm, or at least 28 N/mm, or at least 29 N/mm;
(xv) An across stitch tear strength as measured by SATRA test method TM 5 of at least 25 N/mm, or at least 27 N/mm, or at least 30 N/mm, or at least 32 N/mm, or at least 34 N/mm;
(xvi) An along Die C tear strength as measured by ASTM D624 of at least 12 N/mm, or at least 13 N/mm, or at least 14 N/mm, or at least 15 N/mm, or at least 16 N/mm, or at least 17 N/mm;
(xvii) An across Die C tear strength as measured by ASTM D624 of at least 12 N/mm, or at least 13 N/mm, or at least 14 N/mm, or at least 15 N/mm, or at least 16 N/mm;
(xviii) A resistance to cut growth on flexing as measured by the Ross Flex Test SATRA test method TM 60 of less than 0.04 mm/kc, or less than 0.02 mm/ck, or less than 0.01 mm/kc;
(xix) A 90° peel strength as measured by SATRA test method TM 411 at a crosshead speed of 100 mm/min, 48 h at 23° C. and 50% humidity, and room temperature, of greater than about 1.5 N/mm.

The compositions described herein provide a footwear sole with a well-balanced combination of desired properties, such as a relatively low density comparable to or even lower than that of currently used EVA or polyurethane, a compression set lower than the common level about 30%, and the ability to retain sufficient weldability after crosslinking to eliminate or reduce the need for adhesives during the subsequent bonding process, all of which would both increase production efficiency and impart targeted performance to the final product of footwear.

In addition, other properties of the footwear described herein may include slip resistance and abrasion durability comparable to those of existing sole materials, and processability capability of taking very defined molding details.

In some embodiments, shoe soles comprising the compositions described herein have improved abrasion resistance. As the shoe sole is exposed to different surfaces during walking, this can cause the abrasion of the sole profile, which can lead possibilities for slip or fall of the footwear user. Abrasion resistance may be measured according to ISO20344, ISO20345, ISO12770.

In some embodiments, shoe soles comprising the compositions described herein have improved flexural modulus and flexural fatigue resistance. As the user of the footwear walks, the anatomy of walking requires flexing of the shoe in the metatarsal area. Consistent sole flexing can cause cracks, which lead to reduction of functional characteristics the shoe, such as comfort, water resistance, etc.

In some embodiments, shoe soles comprising the compositions described herein have improved compression set over a variety of temperature conditions.

In some embodiments, shoe soles comprising the compositions described herein have improved slip resistance.

To achieve targeted properties at certain specific levels, commonly used compositions for manufacturing footwear soles based on EVA plus a plastomer may need to have the polymer phase fully crosslinked, which would result in loss of weldability in the subsequent bonding process of the sole with the upper. In contrast, the propylene-based elastomer described herein, particularly when used with an amount of about 30 phr to about 100 phr relative to the cross linkable phase, can ensure weldability by maintaining sufficient thermoplastic phase in the polymer composition after the crosslinking reaction.

The footwear sole may comprise the propylene-based elastomer described herein in an amount of about 30 phr to about 100 phr, or about 50 phr to about 100 phr, or about 55 phr to about 95 phr, or about 60 phr to about 90 phr, or about 65 phr to about 85 phr, or about 70 phr to about 80 phr, for example, about 50 phr, about 55 phr, about 60 phr, about 65 phr, about 70 phr, about 75 phr, about 80 phr, about 85 phr, about 90 phr, about 95 phr, or about 100 phr, relative to the total of the propylene-based elastomer and the ethylene copolymer (if present). In some embodiments, the propylene-based elastomer is present in the composition in an amount of about 40 to 50 phr relative to the other polymeric components.

The present invention also relates to a footwear comprising a footwear upper and the footwear sole described herein. Preferably, the footwear upper comprises a composition comprising about 20 to about 100 phr of a propylene-based elastomer containing at least about 50 wt % propylene-derived units and about 5 to about 35 wt % ethylene-derived units, based on total weight of the propylene-based elastomer. The footwear upper composition may also comprise from about 5 to about 60 phr of an ethylene-based copolymer. In preferred embodiments, the footwear upper is made from the same propylene-based elastomer present in the footwear sole. More preferably, the corresponding compositions based on the propylene-based elastomer in both the footwear upper and the footwear sole are similar to one another or in some cases are the same. In the case where the entire article of footwear is made from the same material, or better still, a uniform composition, unified recycling of the material can be facilitated for further use, thus boosting recycling efficiency and creating environmental benefits.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

The following materials were used in the examples.

Exact™ 0201 is an ethylene-octene copolymer available from ExxonMobil Chemical Company. Exact™ 0201 has a density of 0.902 g/cc, a melt index of 1.1 g/10 min (190° C., 2.16 kg; ASTM D1238), a Shore D hardness of 43 (ISO 868), a DSC peak melting temperature of 97° C. (ISO 11357), and a Vicat softening temperature (at 10 N) of 82° C. (ISO 306).

Exact™ 0210 is an ethylene-octene copolymer available from ExxonMobil Chemical Company. Exact™ 210 has a density of 0.902 g/cc, a melt index of 10 g/10 min (190° C., 2.16 kg; ASTM D1238), a Shore D hardness of 38 (ISO 868) a DSC peak melting temperature of 97° C. (ISO 11357), and a Vicat softening point (at 10 N) of 75° C. (ISO 306).

Exact™ 9182 is an ethylene-butene copolymer available from ExxonMobil Chemical Company. Exact™ 9182 has a density of 0.884 g/cc, a melt index of 1.2 g/10 min (190° C., 2.16 kg; ASTM D1238), a Shore A hardness of 87 (ASTM D2240), a peak melting temperature of 69° C., and a Vicat softening temperature of 68.9° C.

Escorene™ Ultra FL 00328 is an ethylene vinyl acetate copolymer available from ExxonMobil Chemical Company. Escorene™ Ultra FL 00328 has a vinyl acetate content of 27 wt %, a density of 0.951 g/cc, a melt index of 3.0 g/10 min (190° C., 2.16 kg; ASTM D1238), a peak melting temperature of 163° F., and a Vicat softening temperature of 111° F. (ASTM D1525).

Escorene™ Ultra FL 00218 is an ethylene vinyl acetate copolymer available from ExxonMobil Chemical Company. Escorene™ Ultra FL 00218 has a vinyl acetate of 18.0 wt %, a density of 0.940 g/cm3, a melt index of 1.7 g/10 min (190° C., 2.16 kg; ASTM D1238), a peak melting temperature of 87° C., and a Vicat softening temperature of 62° C. (ASTM D1525).

Vistamaxx™ 3980FL is a propylene-based elastomer available from ExxonMobil Chemical Company. Vistamaxx™ 3980 FL has an ethylene content of about 9 wt %, a density of about 0.878 g/cc (ASTM D1505), a melt index of about 3.7 g/10 min (190° C., 2.16 kg; ASTM D1238), a melt flow rate of about 8 g/10 min (230° C., 2.16 kg), and a Shore D hardness of about 40 (ASTM D2240).

Vistamaxx™ 3020 propylene-based elastomer is a random propylene-ethylene copolymer available from ExxonMobil Chemical Company. Vistamaxx™ 3020 has an ethylene content of 11 wt %, a density of 0.874 g/cc (ASTM D1505), a melt index of 1.1 g/10 min (ASTM D1238; 190° C. and 2.16 kg weight), a MFR of 3 g/10 min (ASTM D1238; 230° C. and 2.16 kg weight), and a Shore D hardness of 34 (ASTM D2240).

Vistamaxx™ 6102 propylene-based elastomer is a reactor-grade blended propylene-based elastomer available from ExxonMobil Chemical Company. Vistamaxx™ 6102 has an overall ethylene content of 16 wt %, a density of 0.862 g/cc (ASTM D1505), a melt index of 1.4 g/10 min (ASTM D1238; 190° C. and 2.16 kg), a MFR of 3 g/10 min (ASTM D1238; 230° C. and 2.16 kg weight), and a Shore A hardness of 66 (ASTM D2240).

The Diene PBE used in the examples was a propylene-ethylene-diene terpolymer made in a solution metallocene polymerization process as described herein. The Diene PBE had a diene content of 3.5 wt % ENB.

Vistalon™ 805 ethylene-propylene copolymer rubber is an EP rubber available from ExxonMobil Chemical Company. Vistalon™ 805 has an ethylene content of about 78 wt %, a propylene content of about 22 wt %, and a Mooney viscosity of 33 MU (ML 1+4, 125° C.; ASTM D1646).

Nordel™ IP 3720P ethylene-propylene-diene rubber is an EPDM rubber available from The Dow Chemical Company. Nordel™ IP 3720P has an ethylene content of 70 wt %, an ethylidene norbornene content of 0.6 wt %, with the remainder being propylene. Nordel™ IP 3720P has a broad molecular weight distribution and a Mooney viscosity of 20 MU (ML 1+4, 125° C.; ASTM D1646).

Sartomer™ 350 is trimethylolpropane trimethacrylate (TMPTMA).

Genitron ACR is an exothermic blowing agent comprising ADC/p-Toluene Sulfonyl Hydrazide.

Genitron SP51016 is an exothermic blowing agent comprising a high activated ADC masterbatch in an EVA carrier containing 60% active ingredient, with an application temperature of 150-200° C.

### Comparative Examples

The formulations used in the Comparative Examples are shown in Table 2. The amount of each material in the formulation is listed in phr, which in these examples is parts per 100 parts of the total amount of ethylene-based plastomer and propylene-based elastomer in the formulation. The samples were prepared using a Buss Kneader, low shear high dispersive single screw extruder with processing at temperatures below the initiation temperatures of the foaming agents and crosslinking agents that were used.

TABLE 2
Formulations (phr) for the Comparative Examples

| Composition No. | C1 | C2 | C3 | C4 | C5 | C6 |
|---|---|---|---|---|---|---|
| EXACT ™ 0201 | 70 | 30 | 30 | 30 | — | — |
| EXACT ™ 0210 | — | — | — | — | — | 30 |
| ESCORENE ™ Ultra FL 00328 | — | — | — | — | 30 | — |
| ESCORENE ™ Ultra FL 00218 | 30 | 70 | — | — | — | — |
| VISTAMAXX ™ 3980FL | — | — | 70 | 70 | 70 | 70 |
| CaCO₃ | 7.5 | 7.5 | 7.5 | 7.5 | 7.5 | 7.5 |
| ZnO | 1 | 1 | 1 | 1 | 1 | 1 |
| Zinc Stearate | 0.8 | 0.8 | 0.8 | 0.8 | 0.8 | 0.8 |
| Stearic Acid | 0.5 | 0.5 | 0.5 | 0.5 | 0.5 | 0.5 |
| Dicumyl Peroxide | 0.75 | 0.75 | 0.75 | 0.75 | 0.75 | 0.75 |
| Sartomer ™ 350 | 0.32 | 0.32 | 0.32 | 0.32 | 0.32 | 0.32 |
| Black Masterbatch (PE Base) | 4 | 4 | 4 | 4 | 4 | 4 |
| Genitron ACR | 3.5 | 3.5 | 3.5 | — | — | 3.5 |
| Genitron SP 51016 | — | — | — | 5.8 | 5.8 | — |
| Total (phr) | 118.37 | 118.37 | 118.37 | 120.67 | 120.67 | 118.37 |

Foamed samples were prepared from each formulation, with the density (ASTM D1505) and compression set (ASTM D395 Method B) of each composition measured. The results are listed in Table 3. The foamed samples were prepared using a single fan gated plaque mold (12 mm thick×100 mm wide×140 long). As seen in Table 3, the foams made from compositions C3, C4, C5, and C6 which contained the propylene-based elastomer instead of the EVA copolymer had decreased compression set (at 24 hours, room temperature, and 22 hours relaxation).

TABLE 3
Density and Compression Set of Comparative Examples

| Composition No. | C1 | C2 | C3 | C4 | C5 | C6 |
|---|---|---|---|---|---|---|
| Density (g/cm³) | 0.45 | 0.5 | 0.41 | 0.36 | 0.34 | 0.44 |
| Compression Set (%) | | | | | | |
| @ 24 hours/Room | — | — | 40 | 29 | 37 | 42 |
| Temperature/3 minutes | | | | | | |
| relaxation | | | | | | |
| @ 24 hours/Room | — | — | 28 | 20 | 22 | 31 |
| Temperature/30 minutes | | | | | | |
| relaxation | | | | | | |
| @ 24 hours/Room | 25 | 33 | 15 | 11 | 9 | 15 |
| Temperature/22 hours | | | | | | |
| relaxation | | | | | | |
| @ 24 hours/50° C./ | — | — | 76 | 75 | 76 | 77 |
| 22 hours relaxation | | | | | | |

### Example 1

The formulations used in Example 1 are shown in Table 4. The amount of each material in the formulation is listed in weight percent, based on the weight of the formulation. The samples were prepared using a Buss Kneader, low shear high dispersive single screw extruder with processing at temperatures below the initiation temperatures of the foaming agents and crosslinking agents that were used

TABLE 4
Example 1 Formulations

| Composition No. | F1 | F2 | F3 | F4 |
|---|---|---|---|---|
| Exact ™ 9182 | 25.34 | 25.34 | 33.79 | — |
| Diene PBE | — | — | — | 25.34 |
| Vistamaxx ™ 6102 | 59.14 | — | — | — |
| Vistamaxx ™ 3020 | — | 59.14 | 50.69 | 59.14 |
| CaCO₃ | 6.34 | 6.34 | 6.34 | 6.34 |
| ZnO | 0.84 | 0.84 | 0.84 | 0.84 |
| Zinc Stearate | 0.68 | 0.68 | 0.68 | 0.68 |
| Stearic Acid | 0.42 | 0.42 | 0.42 | 0.42 |
| Dicumyl Peroxide | 0.63 | 0.63 | 0.63 | 0.63 |
| Sartomer 350 | 0.27 | 0.27 | 0.27 | 0.27 |
| Genitron ACR | 2.96 | 2.96 | 2.96 | 2.96 |
| Black MB (PE Base) | 3.38 | 3.38 | 3.38 | 3.38 |
| Total (wt %) | 100% | 100% | 100% | 100% |

Physical properties and compound rheology of the formulations in Table 4 were measured, with the results in Table 5.

TABLE 5
Example 1 Compound Rheology and Physical Properties

| Composition No. | F1 | F2 | F3 | F4 |
|---|---|---|---|---|
| MDR arc ± 0.5, 180° C. | | | | |
| ML [dNm] | 0.28 | 0.22 | 0.34 | 0.13 |
| MH [dNm] | 0.31 | 0.25 | 0.64 | 0.15 |
| MH − ML [dNm] | 0.03 | 0.03 | 0.30 | 0.02 |
| Tc90 [min] | 58.3 | 21.6 | 1.0 | 60.0 |
| Peak Rate [dNm/min] | 0.03 | 0.03 | 0.70 | 0.01 |
| Pellet Hardness | | | | |
| Shore A | 90 | 89 | 93 | 95 |
| Shore D | 34 | 35 | 33 | 42 |

Foamed samples were prepared from each formulation, with the density (ASTM D1505) and compression set (ASTM D395 Method B) of each composition measured. The results are listed in Table 6. The foamed samples were prepared using a single fan gated plaque mold (12 mm thick×100 mm wide×140 long). As seen by comparing Table 6 and Table 3, the foams made with 70 phr of Vistamaxx™ 6102 or 3020 (i.e., formulations F1 and F2) had decreased compression set (at 24 hours, room temperature, with 22 or 24 hours relaxation) as compared to the foams made with Vistamaxx™ 3980 (i.e., formulations C3, C4, C5, and C6 in the comparative examples). The foam made with formulation F4 which contained a Diene PBE instead of an ethylene-based copolymer also exhibited decreased compression set.

TABLE 6
Example 1 Density and Compression Set

| Composition No. | F1 | F2 | F3 | F4 |
|---|---|---|---|---|
| Density (g/cm³) | 0.184 | 0.229 | 0.236 | 0.167 |
| Compression Set (%) | | | | |
| @ 24 hours/Room Temperature | 20 | 11 | 18 | 12 |
| @ 24 hours/50° C. | 80 | 70 | 76 | 81 |
| @ 24 hours/Room Temperature/ | 6 | 5 | 13 | 9 |
| 24 hours relaxation | | | | |
| @ 24 hours/50° C./ | 85 | 70 | 75 | 79 |
| 24 hours relaxation | | | | |

### Example 2

Sample formulations for Example 2 are listed in Table 7. The amount of each material in the formulation is listed in phr, based on total parts of the ingredient per 100 parts of the total amount of the ethylene-based copolymer and propylene-based elastomer. The samples were produced using a laboratory scale co-rotating twin screw extruder where the process temperatures were maintained below the initiation temperature of the foaming agents and the cross linking agents used.

In the Example 2 formulations the type of propylene-based elastomer and ethylene-based copolymer used were to evaluate the resulting compound flexibility.

TABLE 7

| | | | | | | | | | | |
|---|---|---|---|---|---|---|---|---|---|---|
| Composition No. | F5 | F6 | F7 | F8 | F9 | F10 | F11 | F12 | F13 | F14 |

Example 2 Formulations (phr)

| | | | | | | | | | | |
|---|---|---|---|---|---|---|---|---|---|---|
| Exact ™ 0201 | 25 | 20 | — | 10 | — | 25 | 20 | — | — | — |
| Nordel ™ IP 3720P | — | — | — | 60 | — | — | — | — | — | — |
| Vistalon ™ 805 | — | 20 | 50 | — | 50 | — | 20 | — | 50 | 60 |
| Vistamaxx ™ 3020 | 75 | 60 | 50 | 30 | — | 75 | 60 | 40 | — | — |
| Vistamaxx ™ 6102 | — | — | — | — | 50 | — | — | — | 50 | 40 |
| Diene PBE | — | — | — | — | — | — | — | 60 | — | — |
| CaCO3 | 7.5 | 7.5 | 7.5 | 7.5 | 7.5 | 7.5 | 7.5 | 7.5 | 7.5 | 7.5 |
| ZnO | 1 | 1 | 1 | 1 | 1 | 1 | 1 | 1 | 1 | 1 |
| Zinc Stearate | 0.8 | 0.8 | 0.8 | 0.8 | 0.8 | 0.8 | 0.8 | 0.8 | 0.8 | 0.8 |
| Stearic Acid | 0.5 | 0.5 | 0.5 | 0.5 | 0.5 | 0.5 | 0.5 | 0.5 | 0.5 | 0.5 |
| Sartomer 350 | 0.32 | 0.32 | 0.32 | 0.32 | 0.32 | 0.32 | 0.9 | 0.9 | 0.9 | 0.9 |
| Genitron ACR or Fascom CS Plus | 3.5 | 3.5 | 3.5 | 3.5 | 3.5 | 3.5 | 3.5 | 3.5 | 3.5 | 3.5 |
| Dicumyl Peroxide | 0.75 | 0.75 | 0.75 | 0.75 | 0.75 | 0.75 | 1.2 | 1.2 | 1.2 | 1.2 |
| Plastol 537 or Paramound 6001R | — | — | — | — | — | — | — | 8 | 8 | 8 |
| Na Bicarbonate | — | — | — | — | — | — | — | — | — | — |
| Paraffinic Wax | — | — | — | — | — | — | — | 1 | 1 | 1 |
| Total (phr) | 114.37 | 114.37 | 114.37 | 114.37 | 114.37 | 114.37 | 114.37 | 124.4 | 124.4 | 124.4 |

Example 2 Testing Data

| | | | | | | | | | | |
|---|---|---|---|---|---|---|---|---|---|---|
| Flex Modulus in direction of | — | — | — | 10.6 | — | 24.6 | 17.1 | 6.1 | 3.8 | 6.1 |
| flow (MPa) | | | | | | | | | | |
| Flex Modulus perpendicular to | — | — | — | 8.5 | — | 17.7 | 18.6 | 5.5 | 3.4 | 3.8 |
| flow (MPa) | | | | | | | | | | |
| Hardness Shore A | — | — | — | 67 | — | 81.5 | 75.2 | 60.6 | 45.6 | 51.3 |
| Density g/cm³ | — | — | — | 0.63 | — | 0.50 | 0.48 | 0.44 | 0.42 | 0.53 |
| Abrasion (mm³/40 m), ISO4649 | — | — | — | 305 | — | — | 317 | 832 | 920 | 754 |
| Compression set % at 23° C. | — | — | — | 45 | — | 26 | 24 | 19 | 31 | 36 |
| Compression set % at 50° C. | — | — | — | 74 | — | 72 | 70 | 81 | 87 | 89 |
| Average Coefficient of Friction, | — | — | — | 1.07 | — | 0.66 | 1.24 | 1.01 | 1.38 | 0.98 |
| glass substrate | | | | | | | | | | |

### Example 3

Sample formulations for Example 3 are listed in Table 8. The formulations used are shown in Table 8. The amount of each material in the formulation is listed in phr, which in these examples is parts per 100 parts of the total amount of propylene-based elastomer and EP Rubber.

In Example 3, the compound flexibility was evaluated by varying the propylene-based elastomers and the ethylene-based copolymers that were used. The formulations were also designed to improve injection molding processing and melt flow, in combination with improvements in the compound flexibility. In this Example 3, the type of foaming agent used was also varied to evaluate alternative open-cell foam structures to enhance the shoe sole performance.

TABLE 8

| | | | | |
|---|---|---|---|---|
| Composition No. | F15 | F16 | F17 | F18 |

Example 3 Formulations (phr)

| | | | | |
|---|---|---|---|---|
| Vistamaxx ™ 6102 | 50 | 50 | 50 | 40 |
| Vistalon ™ 805 | 50 | 50 | 50 | 60 |
| CaCO3 | 7.5 | 7.5 | 7.5 | 7.5 |
| ZnO | 1 | 1 | 1 | 1 |
| Zn Stearate | 0.8 | 0.8 | 0.8 | 0.8 |
| Stearic Acid | 0.5 | 0.5 | 0.5 | 0.5 |
| Sartomer 350 | 0.32 | — | 0.32 | 0.32 |
| Genitron ACR or Fascom CS Plus | 3.5 | 3.5 | — | 3.5 |
| Dicumyl Peroxide | 0.75 | — | 0.75 | 0.75 |
| Plastol 537 or Paramound 6001R | 8 | 8 | 8 | 8 |
| Na Bicarbonate | — | — | 3.5 | — |
| Paraffinic Wax | 1 | 1 | 1 | 1 |
| Total (phr) | 123.37 | 122.3 | 123.37 | 123.37 |

Example 3-Testing Data

| | | | | |
|---|---|---|---|---|
| Flex Modulus in direction of | — | — | — | — |
| flow (MPa) | | | | |
| Flex Modulus perpendicular to | 4.8 | 3.9 | 9 | 4.4 |
| flow (MPa) | | | | |
| Hardness Shore A | 41 | 43 | 64 | — |
| Density g/cm³ | 0.54 | 0.51 | 0.67 | 0.52 |
| Abrasion (mm³/40 m), ISO4649 | 491 | 949 | 297 | 926 |
| Compression set % at 23° C. | 46 | 48 | 47 | 52 |
| Compression set % at 50° C. | 91 | 90 | 87 | 93 |
| Average Coefficient of Friction, | 1.73 | 1.43 | 1.03 | 1.35 |
| glass substrate | | | | |

Table 9 shows the peel strength of shoe assemblies for certain formulations of the invention. Peel strength was evaluated at 6 positions on the bottom sole of a right shoe: position 1 indicates the toe cap of the shoe, position 2 indicates the left mid-point of the forefoot of the shoe, position 3 indicates the left middle of the midpoint of the shoe, position 4 indicates the heel of the shoe, position 5 indicates the right middle of the midpoint of the shoe, and position 6 indicates the right mid-point of the forefoot of the shoe. Formulation F7 showed the highest average bond strength for all positions tested.

TABLE 9
Peel Strength Data (N/mm)

| Composition No. | F5 | F7 | F9 | F13 |
|---|---|---|---|---|
| Shoe Position 1 | 1.92 | 2.69 | 1.73 | 2.68 |
| Shoe Position 2 | 1.34 | 3.11 | 3.83 | 3.59 |
| Shoe Position 3 | 2.20 | 3.56 | 3.50 | 1.92 |
| Shoe Position 4 | 4.85 | 4.33 | 2.11 | 1.58 |
| Shoe Position 5 | 1.72 | 2.07 | 2.06 | 1.74 |
| Shoe Position 6 | 3.53 | 3.18 | 2.69 | 2.20 |

Having described the various aspects of the compositions herein, further specific embodiments of the invention include those set forth in the following paragraphs.

### Embodiment A

A footwear composition comprising a foam comprising:
(a) a propylene-based elastomer that comprises propylene-derived units and from about 5 to about 30 wt % of α-olefin-derived units, based on the weight of the propylene-based elastomer, and where the propylene-based elastomer has at least four of the following properties:
   (i) a melting temperature (Tm) of less than 110° C.;
   (ii) a heat of fusion (Hf) of less than about 50 J/g;
   (iii) a melt index of (ASTM D-1238; 2.16 kg, 190° C.) of less than or equal to about 10 g/10 min;
   (iv) a melt flow rate (ASTM D-1238; 2.16 kg, 230° C.) of less than about 15 g/10 min;
   (v) a weight average molecular weight (Mw) of from about 100,000 to about 500,000 g/mol;
   (vi) a number average molecular weight (Mn) of from about 50,000 to about 500,000 g/mol;
   (vii) a molecular weight distribution (Mw/Mn) of less than about 5; and
   (viii) a Shore D hardness of less than about less than about 50; and
(b) an ethylene-based copolymer that comprises ethylene-derived units and at least 20 wt % α-olefin derived units.

### Embodiment B

The footwear composition of Embodiment A, wherein the propylene-based elastomer is a propylene-ethylene copolymer comprising from about 9 to about 17 wt % ethylene, and has at least four of the following properties: (i) a Tm of from about 40 to about 70° C.; (ii) a Hf of from about 7.0 to about 25 J/g; (iii) a melt index of from about 0.5 to about 3.0 g/10 min; (iv) a melt flow rate of from about 0.5 to about 10 g/10 min; (v) a Mw of from about 240,000 to about 300,000 g/mol; (vi) a (Mn of from about 110,000 to about 140,000 g/mol; (vii) a MWD of from about 0.5 to about 5; and (viii) a Shore D hardness of from about 10 to about 50.

### Embodiment C

The footwear composition of Embodiment A, wherein the propylene-based elastomer is a propylene-ethylene copolymer comprising from about 10 to about 25 wt % ethylene-derived units and has at least four of the following properties (i) Tm of from 80 to about 110° C.; (ii) a Hf of from about 1.0 to about 15 J/g; (iii) a melt index of from about 0.5 to about 3.0 g/10 min; (iv) a melt flow rate of from about 0.5 to about 10 g/10 min; (v) a Mw of from about 175,000 to about 260,000 g/mol; (vi) a Mn of from about 90,000 to about 130,000 g/mol; (vii) a MWD of from about 0.5 to about 10; and (viii) a Shore D hardness of less than 30.

### Embodiment D

The footwear composition of any one of Embodiments A to C, wherein the ethylene-based copolymer has a Mooney viscosity (ML [1+4], 125° C.) of less than 50.

### Embodiment E

The footwear composition of any one of Embodiments A to D, wherein the ethylene-based copolymer further comprises less than 5 wt % diene-derived units.

### Embodiment F

The footwear composition of any one of Embodiments A to E, wherein the foam was produced using a foaming agent comprising azodicarbonamide, sodium bicarbonate, thermally expandable microspheres, or combinations thereof.

### Embodiment G

The footwear composition of any one of Embodiments A to F, wherein the foam is cured by e-beam radiation or UV radiation.

### Embodiment H

The footwear composition of any one of Embodiments A to G, wherein the foam is cured using a curing agent comprising peroxide.

### Embodiment I

The footwear composition of any one of Embodiments A to H, wherein the foam further comprises a propylene-ethylene-diene copolymer that comprises propylene-derived units, from about 5 to about 30 wt % ethylene-derived units, and from about 0.05 to about 6 wt % diene-derived units.

### Embodiment J

The footwear composition of any one of Embodiments A to I, wherein the foam has a density of less than about 0.65 g/cm³ and has a compression set at room temperature of less than about 25%.

### Embodiment K

The footwear composition of any one of Embodiments A to J, wherein the foam has a compression set at 50° C. of less than 75%.

### Embodiment L

The footwear composition of any one of Embodiments A to K, wherein the foam has a coefficient of friction at wet conditions of at least 0.50.

### Embodiment M

The footwear composition of any one of Embodiments A to L, wherein the foam has a coefficient of friction at dry conditions of at least 0.50.

### Embodiment N

The footwear composition of any one of Embodiments A to M, wherein the foam has a DIN abrasion resistance of less than 250 mm³.

For purposes of convenience, various specific test procedures are identified above for determining certain properties. However, when a person of ordinary skill reads this patent and wishes to determine whether a composition or polymer has a particular property identified in a claim, then any published or well-recognized method or test procedure can be followed to determine that property, although the specifically identified procedure is preferred. Each claim should be construed to cover the results of any of such procedures, even to the extent different procedures can yield different results or measurements. Thus, a person of ordinary skill in the art is to expect experimental variations in measured properties that are reflected in the claims.

As used herein, the phrases “substantially no,” and “substantially free of” are intended to mean that the subject item is not intentionally used or added in any amount, but may be present in very small amounts existing as impurities resulting from environmental or process conditions.

All documents described herein are incorporated by reference herein, including any priority documents and/or testing procedures. When numerical lower limits and numerical upper limits are listed herein, ranges from any lower limit to any upper limit are contemplated. As is apparent from the foregoing general description and the specific embodiments, while forms of the invention have been illustrated and described, various modifications can be made without departing from the spirit and scope of the invention. Accordingly, it is not intended that the invention be limited thereby.

What is claimed is:

1. A footwear composition comprising a foam comprising:
(a) a propylene-based elastomer that comprises propylene-derived units and from 5 to 30 wt % of α-olefin-derived units, based on the weight of the propylene-based elastomer, and where the propylene-based elastomer has at least four of the following properties:
(i) a melting temperature (Tm) of less than 110° C.;
(ii) a heat of fusion (Hf) of less than 50 J/g;
(iii) a melt index of (ASTM D-1238; 2.16 kg, 190° C.) of less than or equal to 10 g/10 min;
(iv) a melt flow rate (ASTM D-1238; 2.16 kg, 230° C.) of less than 15 g/10 min;
(v) a weight average molecular weight (Mw) of from 100,000 to 500,000 g/mol;
(vi) a number average molecular weight (Mn) of from 50,000 to 500,000 g/mol;
(vii) a molecular weight distribution (Mw/Mn) of less than 5; and
(viii) a Shore D hardness of less than 50; and
(b) an ethylene-based copolymer that comprises at least 50 wt % ethylene-derived units and at least 20 wt % α-olefin derived units.

2. The footwear composition of claim 1, wherein the propylene-based elastomer is a propylene-ethylene copolymer comprising from 9 to 17 wt % ethylene, and has at least four of the following properties: (i) a Tm of from 40 to 70° C.; (ii) a Hf of from 7.0 to 25 J/g; (iii) a melt index of from 0.5 to 3.0 g/10 min; (iv) a melt flow rate of from 0.5 to 10 g/10 min; (v) a Mw of from 240,000 to 300,000 g/mol; (vi) a (Mn of from 110,000 to 140,000 g/mol; (vii) a MWD of from 0.5 to 5; and (viii) a Shore D hardness of from 10 to 50.

3. The footwear composition of claim 1, wherein the propylene-based elastomer is a propylene-ethylene copolymer comprising from 10 to 25 wt % ethylene-derived units and has at least four of the following properties (i) Tm of from 80 to 110° C.; (ii) a Hf of from 1.0 to 15 J/g; (iii) a melt index of from 0.5 to 3.0 g/10 min; (iv) a melt flow rate of from 0.5 to 10 g/10 min; (v) a Mw of from 175,000 to 260,000 g/mol; (vi) a Mn of from 90,000 to 130,000 g/mol; (vii) a MWD of from 0.5 to 10; and (viii) a Shore D hardness of less than 30.

4. The footwear composition of claim 1, wherein the ethylene-based copolymer has a Mooney viscosity (ML [1+4], 125° C.) of less than 50.

5. The footwear composition of claim 1, wherein the ethylene-based copolymer further comprises diene-derived units in an amount greater than zero and less than 5 wt %.

6. The footwear composition of claim 1, wherein the foam was produced using a foaming agent comprising azodicarbonamide, sodium bicarbonate, thermally expandable microspheres, or combinations thereof.

7. The footwear composition of claim 1, wherein the foam is cured by e-beam radiation or UV radiation.

8. The footwear composition of claim 1, wherein the foam is cured using a curing agent comprising peroxide.

9. The footwear composition of claim 1, wherein the foam further comprises a propylene-ethylene-diene copolymer that comprises propylene-derived units, from 5 to 30 wt % ethylene-derived units, and from 0.05 to 6 wt % diene-derived units.

10. The footwear composition of claim 1, wherein the foam has a density of less than 0.65 g/cm³ and has a compression set at room temperature of less than 25%.

11. The footwear composition of claim 1, wherein the foam has a compression set at 50° C. of less than 75%.

12. The footwear composition of claim 1, wherein the foam has a coefficient of friction at wet conditions of at least 0.50.

13. The footwear composition of claim 1, wherein the foam has a coefficient of friction at dry conditions of at least 0.50.

14. The footwear composition of claim 1, wherein the foam has a DIN abrasion resistance of less than 250 mm³.
